(19) United States
(12) Patent Application Publication
(10) Pub. No.: US 2021/0027954 A1
(43) Pub. Date: Jan. 28, 2021

(54) ADDITIVE MANUFACTURING USING ELECTROCHEMICALLY ACTIVE FORMULATIONS

(71) Applicant: Ramot at Tel-Aviv University Ltd., Tel-Aviv (IL)

(72) Inventors: Diana GOLODNITSKY, Tel-Aviv (IL); Yosef KAMIR, Tel-Aviv (IL); Heftsi RAGONES, Tel-Aviv (IL); Svetlana MENKIN BACHBUT, Tel-Aviv (IL)

(73) Assignee: Ramot at Tel-Aviv University Ltd., Tel-Aviv (IL)

(21) Appl. No.: 17/068,866

(22) Filed: Oct. 13, 2020

Related U.S. Application Data
(63) Continuation of application No. PCT/IL2019/050445, filed on Apr. 17, 2019.
(60) Provisional application No. 62/658,693, filed on Apr. 17, 2018.

(51) Int. Cl. H01G 11/26; B22F 3/00; H01M 4/04; H01M 10/0525; H01M 4/40; H01M 4/58; B29C 64/118

(52) U.S. Cl. CPC H01G 11/26; B22F 3/008; H01M 4/0471; H01M 10/0525; B33Y 70/00; H01M 4/5815; B29C 64/118; B22F 2998/10; H01M 4/405

(57) ABSTRACT

A method of manufacturing an electrochemical system comprising an electrode is described herein, comprising dispensing, in a configured pattern corresponding to the shape of the electrode, a model composition which comprises a substance capable of reversibly releasing an electrochemically-active agent (such as lithium) or depleted form of same, wherein dispensing comprises heating a filament comprising the model composition and dispensing a heated composition. Further described is an electrochemical system comprising an electrode which comprises a composite material, as well as batteries and supercapacitors comprising such a system. The composite material comprises a thermoplastic polymer and substance capable of reversibly releasing an electrochemically-active agent (such as lithium) or depleted form of same, wherein at least 20 weight percents of the composite material is thermoplastic polymer.

### RELATED APPLICATIONS

This application is a Continuation of PCT Patent Application No. PCT/IL2019/050445 having International filing date of Apr. 17, 2019, which claims the benefit of priority under 35 USC § 119(e) of U.S. Provisional Patent Application No. 62/658,693 filed on Apr. 17, 2018. The contents of the above applications are all incorporated by reference as if fully set forth herein in their entirety.

### FIELD AND BACKGROUND OF THE INVENTION

The present invention, in some embodiments thereof, relates to additive manufacturing and, more particularly, but not exclusively, to compositions and methods usable in additive manufacturing of electrochemical systems such as, but not limited to, batteries.

Additive manufacturing (AM), or solid freeform fabrication (SFF), is generally a process in which a three-dimensional (3D) object is manufactured utilizing a computer model of the objects. The basic operation of any AM system consists of slicing a three-dimensional computer model into thin cross sections, translating the result into two-dimensional position data and feeding the data to control equipment which manufacture a three-dimensional structure in a layerwise manner.

Various AM technologies exist, amongst which are stereolithography, digital light processing (DLP), and three-dimensional (3D) printing. Such techniques are generally performed by layer by layer deposition and solidification of one or more building materials.

In three-dimensional printing processes, for example, a building material is dispensed from a printing head having a set of nozzles to deposit layers on a supporting structure. Depending on the building material, the layers may then solidify, harden or be cure, optionally using a suitable device.

Generally, in AM, three-dimensional objects are fabricated based on computer object data in a layerwise manner by forming a plurality of layers in a configured pattern corresponding to the shape of the objects. The computer object data can be in any known format, including, without limitation, a Standard Tessellation Language (STL) or a StereoLithography Contour (SLC) format, Virtual Reality Modeling Language (VRML), Additive Manufacturing File (AMF) format, Drawing Exchange Format (DXF), Polygon File Format (PLY) or any other format suitable for Computer-Aided Design (CAD).

Each layer is formed by additive manufacturing apparatus which scans a two-dimensional surface and patterns it. While scanning, the apparatus visits a plurality of target locations on the two-dimensional layer or surface, and decides, for each target location or a group of target locations, whether or not the target location or group of target locations is to be occupied by the building material, and which type of building material is to be delivered thereto. The decision is made according to a computer image of the surface.

The demand for free form-factor, space efficient, energy storage devices has been recently added to the ever-growing need for high specific energy and high-power capability, long-cycle-life and safe energy storage devices. Free form-factor design of energy storage devices provokes new implementations, never before supported by traditional battery structures. In order to enable free form-factor energy storage devices, efforts have been exerted towards the development of three-dimensional microbatteries [Roberts et al., J Mater Chem 2011, 21:9876-9890; Nathan et al., J Microelectromechanical Syst 2005, 14:879-885]. The power output of a three-dimensional microbattery are expected to be up to two orders of magnitude higher than of a two-dimensional battery of equal size, as a result of the higher ratio of electrode-surface-area to volume and lower ohmic losses. Within a battery electrode, a 3D architecture gives mesoporosity, increasing power by reducing the length of the diffusion path; in the separator region it can form the basis of a robust but porous solid, isolating the electrodes and immobilizing an otherwise fluid electrolyte.

Some proposed 3D architectures include the use of vertical “posts” connected to a substrate, in which the layered battery structure is formed around the posts. Other architectures are based on the deposition of electrodes and electrolyte layers on a graphite mesh current collector for anode and cathode or on perforated silicon, glass or polymer substrates [Roberts et al., J Mater Chem 2011, 21:9876-9890; Cohen et al., Electrochim Acta 2018, 265:690-701].

Despite extensive efforts in the field, the performance of current 3D-printed batteries is still far from those of the state-of-the-art commercial batteries, in which the electrodes are fabricated by conventional doctor-blade casting technique. The development of all-3D-printed electrochemical devices is hindered by several technical issues such as nozzle clogging, particles aggregation in printing media, insufficient printer resolution, large electrode thickness and rough surface finish of printed parts [Nathan et al., J Microelectromechanical Syst 2005, 14:879-885].

The structure of a 3D-printed battery (3D-PB) is more complex than that of conventional planar-electrode batteries, since it implies high-aspect ratio and complex-shape electrode architectures [D. Golodnitsky, E. Strauss and S. Menkin, in Printed Batteries: Materials, Technologies and Applications, ed. C. M. C. Senentxu Lanceros-Méndez, John Wiley & Sons, Inc., 1st Ed., 2018].

Printed batteries are classified in two main categories, sandwich-type and in-plane-type designs.

The sandwich-type configuration, in which every component is placed in a different plane and stacked layer-by-layer, is the classic design for these electrochemical devices. Two symmetrical or asymmetrical electrode layers are separated by the electrolyte/separator layer, forming a complete battery. However, such cell design might be limiting when the demand for small footprint energy storage in the device is required [Tian et al., Adv Energy Mater 2007, 7:1-17].

In the in-plane type design, parallel microelectrodes are arranged or patterned on the same plane on a substrate. The cathode and anode are patterned in a very limited footprint area. The accurately controlled distance between the electrodes can be achieved with the use of advanced microfabrication methods. In-plane batteries with integrated microelectrodes possess multiple advantages over the electrodes of 3D microbatteries prepared by deposition techniques. However, the manufacture of in-plane batteries has required complex and costly technologies. Generally, a patterned mask and a resist are essential for microelectromechanical system-based device fabrication, which leads to a high cost.

The use of 3D printing has been investigated as an alternative method for producing batteries. The electrodes in most printed batteries are prepared by extrusion-based methods. Extrusion-based 3D printing employs a three-axis motion stage to draw patterns by robotically depositing material (e.g., squeezing “ink” through a micro-nozzle). This technique can be divided into droplet-based approaches (e.g., ink-jet printing and hot-melt printing) and filamentary-based approaches (e.g., robocasting and fused filament fabrication), based on the rheological properties of the ink materials [Zhang et al., Nano Energy 2017, 40:418-431]. Two important criteria must be addressed to formulate the printable materials. Firstly, the viscoelastic properties need to be controllable so that they can flow properly in extrusion or vibration deposition. Secondly, the mechanical stiffness and strength of the printable materials must be sufficient to support the entire structure during the deposition and rapid solidification processes.

The use of nanomaterials in 3D printing may facilitate electrochemical energy storage due to their high surface area and ease of ionic transport. The combination of nanomaterials with 3D printing can be applied in two ways: 1) manually or automatically introducing nanomaterials during the intermittent stoppages of 3D printing of host matrix materials; and 2) premixing the nanomaterials with host matrices, followed by the 3D printing of the nanocomposite mixture. In addition, incorporating nanomaterials may greatly enhance the mechanical properties, electrical conductivity, and functionality of host matrix materials. Furthermore, when the 3D-printed electrodes are composed of nanomaterials, the number of electrochemically active sites significantly increases [Tian et al., Adv Energy Mater 2007, 7:1-17].

Malone et al. [Rapid Prototyp J 2004, 10:58-69] describe the concept of sandwich-type all-printed batteries, based on zinc-air chemistry, by the deposition of zinc, electrolyte, and catalysts, with separator media and electrodes via syringe-assisted extrusion of active-material paste.

Kohlmeyer et al. [J Mater Chem A 2016, 4:16856-16864] report a series of studies on the effects of each component in optimizing the overall performance of a free-standing and current collector-embedded 3D-printed LFP (lithium iron phosphate), LTO (lithium titanate) and LCO (lithium cobalt oxide) batteries. A PVDF-HFP separator is printed directly on top of LFP electrode to form the all-printed battery. The printed LTO, LFP and LCO electrodes were reported to exhibit full utilization of theoretical capacities and good stability with consistent performance over 100 cycles.

Fu et al. [Adv Mater 2016, 28:2587-2594] describe an all-component 3D lithium ion battery with interdigitated electrodes and solid membrane, in which graphene oxide (GO)-based composite is used as an ink to print electrodes by direct ink writing. The inks are aqueous GO-based electrode slurries, consisting of high-concentrated GO with cathode or anode active materials. The highly concentrated GO dispersions are extruded directly from a nozzle and deposited layer-by-layer to form electrodes. As a result of the shear stress induced by the nozzle, the GO flakes are aligned along the extruding direction, which is reported to enhance the electrical conductivity of the electrode. The membrane-ink composite consisting of PVDF-co-HFP and Al₂O₃ nanoparticles is printed into the channels between the electrodes. After drying of the sample, the liquid electrolyte is injected into the channel to fully soak the electrodes. The 3D-printed LiFePO₄/Li₄Ti₅O₁₂ full cell is reported to feature a high electrode mass loading of about 18 mg/cm² when normalized to the overall area of the battery. The full cell is reported to deliver initial charge and discharge capacities of 117 and 91 mA*hour/gram with good cycling stability.

Hu & Sun [J Mater Chem A 2014, 2:10712-10738] and Hu et al. [Adv Energy Mater 2016, 6:1-8] describe 3D printing by slurry extrusion from an air-powered dispenser of a cathode comprising LiMn_{0.21}Fe_{0.79}PO₄-C (LMFP) nanocrystals.

Sun et al. [Adv Mater 2013, 25:4539-4543] describes in-plane interdigitated Li-ion microbattery architectures through 3D printing on a sub-millimeter scale. LFP and LTO served as the cathode and anode electrodes, respectively, in the Li-ion microbattery architecture. The reported discharge properties for LFP-based and LTO-based half-cells were in good agreement with their respective theoretical values.

Zhang et al. [Synth Met 2016, 217:79-86] describe a modified two-step in situ method to print highly conductive graphene, where the enhanced interlayer bonding is specially addressed. Thermally reduced graphene was wrapped and covered by polylactic acid in fused filament fabrication processes.

Li et al. [Mater Des 2017, 119:417-424] describes an extrusion-based additive manufacturing method for fabricating a hybrid 3D structure by using a conventional solution, which resolves the typical challenges in preparing solutions for the extrusion process. A LiMn₂O₄ battery prepared in such a structure exhibited superior performance (117.0 mA*hour/gram and 4.5 mA*hour/cm²), in terms of specific capacity and areal capacity.

Fused filament fabrication (FFF) is a 3D printing technique in which thermoplastic materials are heated and extruded from the dispenser needle in a semi-molten form. After being dispensed on the substrate layer-by-layer, the cold filaments combine into a solidified product [Du et al., J Mater Chem A 2017, 5:22442-22458]. Fused filament fabrication has become especially common among hobbyists as it is generally less costly than other 3D printing techniques; whereas techniques such as photopolymerization and powder sintering, which may provide superior results at a higher cost, are commonly used in commercial printing.

Foster et al. [Sci Rep 2017, 7:42233] report fused filament fabrication of a range of disc electrode configurations using a graphene-based polylactic acid filament (GR-PLA), and propose that 3D printing of graphene-based conductive filaments allows for the simple fabrication of energy storage designs. The GR-PLA electrodes when tested vs. Li exhibited very low capacities, from 0.6 to 15.8 mA*hour/gram. The electrode configurations of Foster et al. [Sci Rep 2017, 7:42233], similarly to perforated GR-PLA substrates described by Cohen et al. [Electrochim Acta 2018, 265:690-701] for 3D microbatteries, neglect the requirement for a current collector, thus offering a simplistic alternative to traditional Li-ion based setups.

Additional background art includes Arthur et al. [MRS Bull 2011, 36:523-531]; Dokko et al. [Electrochem Commun 2007, 9:857-862]; Ferrari et al. [J Power Sources 2015, 286:25-46]; Mazor et al. [J Power Sources 2012, 198:264-272]; Oudenhoven et al. [Adv Energy Mater 2011, 1:10-33]; Sun et al. [ACS Appl Mater Interfaces 2018, 10:2407-2413]; Wang et al. [Electrochem Solid-State Lett 2004, 7:A435-A438]; and Xie et al. [J Electrochem Soc 2016, 163:A2385-A2389].

### SUMMARY OF THE INVENTION

According to an aspect of some embodiments of the invention, there is provided a method of manufacturing an electrochemical system which comprises at least one electrode, the method comprising dispensing, in a configured pattern corresponding to the shape of the electrode, at least a first model composition which comprises at least one substance capable of reversibly releasing an electrochemically-active agent or a depleted form of the substance, wherein dispensing comprises heating a filament comprising the first model composition and dispensing a heated composition.

According to an aspect of some embodiments of the invention, there is provided a method of manufacturing an electrochemical system which comprises at least one lithium-based electrode, the method comprising dispensing, in a configured pattern corresponding to the shape of the electrode, at least a first model composition which comprises at least one substance capable of reversibly releasing lithium or a delithiated form of the substance, wherein dispensing comprises heating a filament comprising the first model composition and dispensing a heated composition.

According to an aspect of some embodiments of the invention, there is provided an electrochemical system which comprises at least one electrode, the electrode comprising a first composite material, the first composite material comprising a thermoplastic polymer and at least one substance capable of reversibly releasing an electrochemically-active agent or a depleted form of the substance, wherein at least 20 weight percents of the first composite material is the aforementioned thermoplastic polymer.

According to an aspect of some embodiments of the invention, there is provided an electrochemical system which comprises at least one lithium-based electrode, the electrode comprising a first composite material, the first composite material comprising a thermoplastic polymer and at least one substance capable of reversibly releasing lithium or a delithiated form of the substance, wherein at least 20 weight percents of the first composite material is the aforementioned thermoplastic polymer.

According to an aspect of some embodiments of the invention, there is provided an electrochemical system which comprises:

(a) at least one lithium-based electrode, the electrode comprising a first composite material, the first composite material comprising a thermoplastic polymer and at least one substance capable of reversibly releasing lithium or a delithiated form of the substance, wherein at least 20 weight percents of the first composite material is the aforementioned thermoplastic polymer;

(b) a current collector in physical contact with at least a portion of the electrode, the current collector comprising a second composite material which comprises a thermoplastic polymer and a conductive material; and

(c) an electrolyte.

According to an aspect of some embodiments of the invention, there is provided an electrochemical system which comprises at least one electrode, manufactured according to the method described herein, according to any of the respective embodiments.

According to an aspect of some embodiments of the invention, there is provided a battery or supercapacitor comprising at least one electrochemical system according to any of the embodiments described herein.

According to an aspect of some embodiments of the invention, there is provided a lithium ion battery or supercapacitor comprising at least one electrochemical system according to any of the embodiments described herein.

According to an aspect of some embodiments of the invention, there is provided a battery comprising an electrochemical system described herein which comprises a cathode (according to any of the respective embodiments described herein), and an anode.

According to an aspect of some embodiments of the invention, there is provided a lithium ion battery comprising an electrochemical system described herein which comprises a cathode (according to any of the respective embodiments described herein), and a lithium ion anode.

According to an aspect of some embodiments of the invention, there is provided a battery comprising an electrochemical system described herein which comprises an anode (according to any of the respective embodiments described herein), and a cathode.

According to an aspect of some embodiments of the invention, there is provided a lithium ion battery comprising an electrochemical system described herein which comprises an anode (according to any of the respective embodiments described herein), and a lithium ion cathode.

According to an aspect of some embodiments of the invention, there is provided a battery comprising an electrochemical system described herein which comprises an anode (according to any of the respective embodiments described herein), and an electrochemical system described herein which comprises a cathode (according to any of the respective embodiments described herein).

According to an aspect of some embodiments of the invention, there is provided a lithium ion battery comprising an electrochemical system described herein which comprises an anode (according to any of the respective embodiments described herein), and an electrochemical system described herein which comprises a cathode (according to any of the respective embodiments described herein).

According to an aspect of some embodiments of the invention, there is provided a battery comprising an electrochemical system described herein which comprises at least two electrodes (according to any of the respective embodiments described herein), and an electrolyte.

According to an aspect of some embodiments of the invention, there is provided a battery or supercapacitor manufactured according to a method of preparing an electrochemical system which comprises an electrolyte, according to any of the respective embodiments described herein.

According to some of any of the embodiments of the invention, the substance is a lithium metal oxide/sulfide.

According to some of any of the embodiments of the invention relating to a lithium metal oxide/sulfide, the lithium metal oxide/sulfide is selected from the group consisting of lithium titanate (LTO), lithium iron phosphate (LFP), lithium cobalt oxide (LCO), lithium manganese oxide (LMO), lithium nickel cobalt aluminum oxide (NCA), and lithium nickel manganese cobalt oxide (NMC).

According to some of any of the embodiments of the invention, the substance is a lithium alloy.

According to some of any of the embodiments of the invention relating to a lithium alloy, the alloy comprises a compound selected from the group consisting of silicon, tin, antimony, germanium, lead, bismuth, magnesium, aluminum and mixtures thereof.

According to some of any of the embodiments of the invention relating to a method, the first model composition further comprises a thermoplastic polymer.

According to some of any of the embodiments of the invention relating to a thermoplastic polymer, the thermoplastic polymer comprises at least one polymer selected from the group consisting of polylactic acid, polyvinyl alcohol, polyvinylpyrrolidone, polyacrylic acid, polymethyl methacrylate, polyvinylidene fluoride, polyvinylidene chloride, polyethylene, polyethylene oxide, polystyrene, polyurethane, carboxymethylcellulose, and poly(ethylene terephthalate).

According to some of any of the embodiments of the invention relating to a thermoplastic polymer, the thermoplastic polymer comprises polylactic acid.

According to some of any of the embodiments of the invention relating to a thermoplastic polymer, the substance capable of reversibly releasing lithium is in a form of particles dispersed in the thermoplastic polymer.

According to some of any of the embodiments of the invention relating to a first composite material, at least 30 weight percents of the first composite material is the thermoplastic polymer.

According to some of any of the embodiments of the invention relating to a first composite material, the first composite material further comprises a plasticizer.

According to some of any of the embodiments of the invention relating to a method, the first model composition further comprises a plasticizer.

According to some of any of the embodiments of the invention relating to a plasticizer, the plasticizer is polyethylene glycol (PEG).

According to some of any of the embodiments of the invention, the electrode is a three-dimensional electrode.

According to some of any of the embodiments of the invention relating to a method, the electrode is a three-dimensional electrode, the method comprising sequentially forming a plurality of layers in the configured pattern, wherein for at least a few of the layers the forming comprises the dispensing of the first model composition.

According to some of any of the embodiments of the invention, the electrochemical system further comprises a current collector which comprises a conductive material, the current collector being in physical contact with at least a portion of the electrode.

According to some of any of the embodiments of the invention relating to a current collector, the current collector comprises a second composite material which comprises a thermoplastic polymer and conductive material.

According to some of any of the embodiments of the invention relating to a second composite material, the second composite material comprises polylactic acid.

According to some of any of the embodiments of the invention relating to a method of manufacturing an electrochemical system comprising a current collector, the method further comprises dispensing a second model composition which comprises the conductive material, wherein dispensing the first and the second model compositions is in a configured pattern corresponding to the shape of the electrochemical system.

According to some of any of the embodiments of the invention relating to a method utilizing a second model composition, dispensing the second model composition comprises heating a filament comprising the second model composition to obtain a heated second model composition and dispensing the heated second model composition.

According to some of any of the embodiments of the invention relating to a method utilizing a second model composition, the second model composition further comprises a thermoplastic polymer.

According to some of any of the embodiments of the invention relating to a method utilizing a second model composition, the second model composition further comprises a thermoplastic polymer which comprises polylactic acid.

According to some of any of the embodiments of the invention relating to a method utilizing a second model composition, the method comprises forming a filament that comprises the first model composition and the second model composition, heating the filament to obtain a heated first model composition and heated second model composition, and dispensing the heated first model composition and heated second model composition.

According to some of any of the embodiments of the invention relating to a filament that comprises the first model composition and the second model composition, a cross-section of the filament that comprises the first model composition and the second model composition comprises the first model composition and second model composition in a predetermined pattern.

According to some of any of the embodiments of the invention relating to an electrochemical system comprising a current collector, the electrode and current collector interlock with one another.

According to some of any of the embodiments of the invention relating to a method of manufacturing a system comprising a current collector, the configured pattern is such that the electrode and the current collector interlock with one another.

According to some of any of the embodiments of the invention relating to a conductive material, the conductive material comprises graphene.

According to some of any of the embodiments of the invention, the electrochemical system comprises at least two electrodes, each of the electrodes comprising a thermoplastic polymer and at least one substance capable of reversibly releasing lithium or a delithiated form of the substance.

According to some of any of the embodiments of the invention relating to an electrochemical system comprising at least two electrodes, at least two of the electrodes are interlaced with respect to one another.

According to some of any of the embodiments of the invention relating to an electrochemical system comprising at least two electrodes, the electrodes comprise a cathode and an anode.

According to some of any of the embodiments of the invention, the electrochemical system comprises at least two electrodes, the electrochemical system comprises at least one electrode which comprises lithium titanate (LTO), and at least one other electrode which comprises a lithium metal oxide selected from the group consisting of lithium iron phosphate (LFP), lithium cobalt oxide (LCO), lithium manganese oxide (LMO), lithium nickel cobalt aluminum oxide (NCA), and lithium nickel manganese cobalt oxide (NMC).

According to some of any of the embodiments of the invention relating to a method, the method comprises manufacturing at least two electrodes, each of the electrodes being independently formed in a respective configured pattern.

According to some of any of the embodiments of the invention relating to a method of manufacturing at least two electrodes, the method comprises manufacturing the electrodes concurrently.

According to some of any of the embodiments of the invention relating to a method of manufacturing at least two electrodes, a respective configured pattern of at least two of the electrodes are such that the at least two electrodes are interlaced with respect to one another.

According to some of any of the embodiments of the invention relating to a method, the first model composition further comprises carbon particles.

According to some of any of the embodiments of the invention relating to a first composite material, the first composite material further comprises carbon particles.

According to some of any of the embodiments of the invention relating to a method, the electrochemical system further comprises an electrolyte, and the method further comprises dispensing a third model composition which comprises the electrolyte, in a configured pattern corresponding to the shape of the electrolyte in the electrochemical system.

According to some of any of the embodiments of the invention relating to a method of manufacturing an electrochemical system comprising an electrolyte, the method comprises dispensing the third model composition concurrently with dispensing the first model composition.

According to some of any of the embodiments of the invention relating to a method of manufacturing an electrochemical system comprising an electrolyte, the third model composition comprises a thermoplastic polymer and at least one compound comprising lithium ions.

According to some of any of the embodiments of the invention relating to an electrochemical system comprising an electrolyte, the electrolyte is in a form of a membrane.

According to some of any of the embodiments of the invention, the electrochemical system comprises an electrochemical half-cell which comprises an electrode described herein and an electrolyte.

According to some of any of the embodiments of the invention relating to an electrochemical system comprising an electrolyte, the system comprises a liquid which comprises the electrolyte.

According to some of any of the embodiments of the invention relating to an electrochemical system comprising an electrolyte, the electrolyte comprises a solid electrolyte.

According to some of any of the embodiments of the invention, the electrode is a cathode and the substance capable of reversibly releasing lithium is a lithium metal oxide/sulfide.

According to some of any of the embodiments of the invention, the electrode is an anode and the substance capable of reversibly releasing lithium is selected from the group consisting of lithium titanate (LTO) and a lithium alloy.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 schematically depicts 3D-printed interlaced electrode networks according to some embodiments of the invention.

FIG. 2 presents images of 3D-printed interlaced electrode networks according to some embodiments of the invention.

FIG. 3 schematically depicts cross-sectional views of core-shell electrodes comprising a current collector core, according to some embodiments of the invention.

FIG. 4 schematically depicts a 3D-printed battery according to some embodiments of the invention, comprising a cathode network and an anode network, each comprising a current collector (cc) core, the networks being separated by a solid electrolyte (SE).

FIGS. 5A and 5B present graphs showing calculated surface area (FIG. 5A) and area-to-volume ratio (FIG. 5B) of model rectangular electrode networks, as a function of network fiber width (D) and distance between network fibers (d).

FIGS. 6A and 6B present photographs showing exemplary PLA filaments comprising LFP (FIG. 6A) or LTO (FIG. 6B) upon extrusion according to some embodiments of the invention.

FIG. 7 presents optical images of exemplary printed electrodes comprising (left to right) LFP-PLA, LTO-PLA, LFP-PLA and LTO-PLA/graphene-PLA double spiral.

FIG. 8 presents ESEM images of an exemplary LFP-PLA electrode at different magnifications.

FIG. 9 presents ESEM images of an exemplary LTO-PLA electrode at different magnifications.

FIG. 10 presents ESEM and EDS mapping images of an exemplary LTO-PLA/graphene-PLA double spiral.

FIG. 11 presents ESEM images of (left to right) pristine LFP, C65 and LTO powders.

FIG. 12 presents TOFSIMS images of exemplary printed LFP-PLA and LTO-PLA electrodes and a double spiral comprising graphene-PLA (BlackMagic) and LTO-PLA components.

FIGS. 13A-13E present graphs showing cathode charge/discharge profiles (FIGS. 13A-13C and 13E) and capacity at charge and discharge as a function of cycle number (FIG. 13D), upon cycling of Li/LiPF₆:EC:DEC/LFP (FIGS. 13A and 13B); Li/LiPF₆:EC:DEC/LTO (FIGS. 13C and 13D) and Li/0.3M LiTFSI-PYR₁₄TFSI/LTO (FIG. 13E) cells with exemplary LFP or LTO cathodes at 50° C.

FIG. 14 presents a photograph showing an exemplary LFP cathode prepared by fused filament fabrication.

FIG. 15 presents a graph showing efficiency and capacity of an exemplary LFP cathode prepared by fused filament fabrication at charge and discharge as a function of cycle number, upon cycling of an Li/LiPF₆:EC:DEC/LFP cell at 50° C. at a current of 25 or 50 μA.

FIG. 16 presents an image of a preliminary model for an electrode prepared by fused filament fabrication according to some embodiments of the invention, comprising PLA (light) and graphene-PLA (dark) combined in a “flower” pattern.

FIG. 17 schematically depicts models for a printed electrode according to some embodiments of the invention, comprising electrode active material (dark pattern) and current collector (light pattern), as separate patterns (left) and as a combined pattern (right).

FIG. 18 presents a flow chart showing an exemplary manufacturing process according to some embodiments of the invention.

### DESCRIPTION OF SPECIFIC EMBODIMENTS OF THE INVENTION

The present invention, in some embodiments thereof, relates to additive manufacturing and, more particularly, but not exclusively, to compositions and methods usable in additive manufacturing of electrochemical systems such as, but not limited to, batteries.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present inventors have surprisingly uncovered that a polymer and an electrochemically active substance such as a lithium metal oxide, lithium metal phosphate, lithium metal sulfide and/or lithium metal silicate (e.g., a lithium metal oxide/phosphate/sulfide/silicate used in lithium ion batteries) or lithium alloy (e.g., silicon-lithium alloy) can be combined in a composition which provides a highly advantageous combination of electrochemical functionality (e.g., reversible lithiation and delithiation of the metal oxide/phosphate/sulfide/silicate or alloy and/or the possibility of using a lithium-free counter-electrode) and mechanical properties which allow for the use of filaments in free filament fabrication. Free filament fabrication provides control over a three dimensional structure (including complex structures such as needed for in plane cell architectures), and allows for relatively rapid and convenient 3D printing at a relatively low cost, in comparison with other 3D printing techniques. For example, free filament fabrication overcomes the need for solvent evaporation as well as the problems of clogging and slow printing rate associated with inks used in 3D printing.

This combination of features represents a promising approach for fabrication of next-generation electrochemical energy-storage devices and has many unique advantages compared with conventional manufacturing methods, such as the ability to readily prepare free form-factor batteries suitable for any given electronic device rather than requiring electronic devices to be designed in accordance with standard battery shapes and sizes.

The inventors have envisioned that printing techniques described herein such as fused filament fabrication can facilitate freeform production of electrodes and other components in customized design, chemical composition, shape and porosity, which may be selected, for example, to reduce the effect of volumetric changes in the electrodes upon charge/discharge. In addition, it enables the microfabrication of asymmetric electrode structures, encapsulation of microbatteries, and/or co-fabrication or direct integration of microbatteries and external electronics (thereby avoiding the post steps of device assembly and packaging). Moreover, printing (optionally concurrent printing) of battery electrodes and a solid electrolyte layer (e.g., by using a multiple extruder device) meets the need for intimate contact and maximal wetting of the electrodes by solid electrolytes.

While reducing the present invention to practice, the inventors have fabricated (as proof of concept) exemplary printable lithium titanate (LTO)-based anodes and lithium iron phosphate (LFP)-based cathodes with high surface areas which exhibit good functionality, as well as an exemplary printable current collector with a pattern complementary to a lithium titanate (LTO)-based anode, thereby enhancing electrode efficiency. In addition, a biodegradable polymer (polylactic acid) was used for filament fabrication, opening the way for potential green battery technology.

As the exemplary anodes, cathodes and current collectors were fabricated using similar methodology (free filament fabrication with the respective active material incorporated into a polymer), the feasibility of 3D printing all such battery components concomitantly has been demonstrated, thereby enabling 3D printing of a functional battery (such as microbatteries, free form-factor batteries) and/or implantable energy storage device.

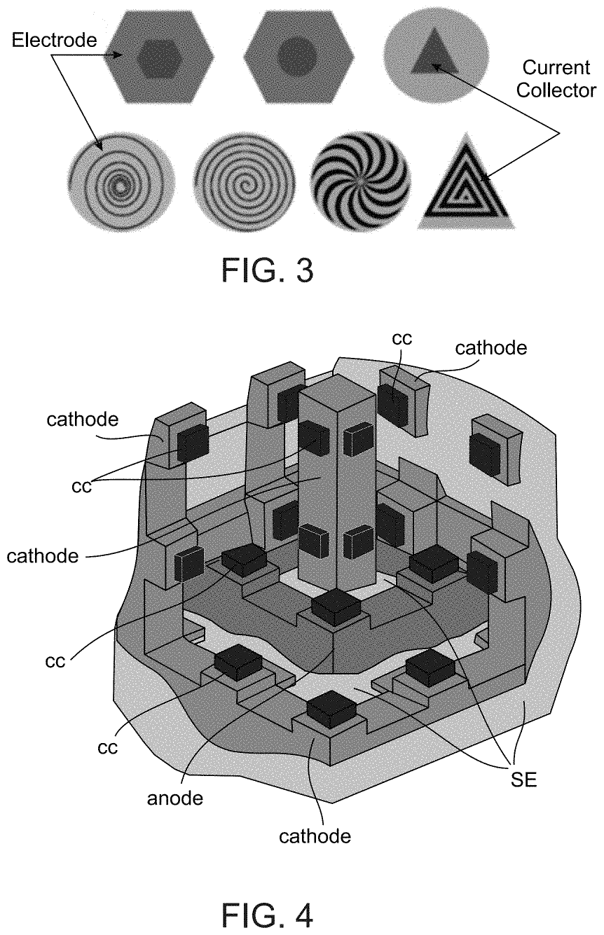

For example, a 3D battery architecture may be manufactured, comprising thin and interweaving fiber-like anode and cathode current collector networks (CCN), in which each current collector is enveloped by a shell of its respective anode or cathode material (see, for example, FIGS. 3 and 4), the anode and cathode networks being separated by a suitable electrolyte, optionally in a form of a membrane, e.g., an ion conducting electrolyte membrane.

An almost unlimited variety of electrode architectures may be prepared by 3D printing as described herein, with minimum feature dimensions ranging from 50 μm to 1 mm, using multiple classes of materials.

Examples of suitable materials include, for example, any thermoplastic material capable of being melted and/or softened sufficiently to allow filament deposition, while retaining sufficient viscosity to maintain a three dimensional shape and retain electrochemically active materials (e.g., a lithium metal oxide/phosphate/sulfide/silicate) therein. The skilled person will be capable of determining conditions (e.g., temperature, pressure) which result in appropriate rheological properties (e.g., for fused filament fabrication) for a given material.

Metamaterials are considered as a new class of artificial materials that derive their properties from newly designed structures and not from base materials. An ideal mechanical metamaterial would simultaneously possess two or more of the following properties: high stiffness, high strength, high toughness, reversible stretchability and low mass density. In addition to the idea of concurrent fused filament fabrication of all components of the battery, current collector networks may optionally be configured a specifically designed arrangement which will enable to account for continuous volumetric changes in the electrodes occurring on charge/discharge. As the result, such a battery is expected to function as multi meta-material electrochemical system. From the perspective of a battery designer, it is important to know the limits of mechanical flexibility of batteries for a given combination of electrode architecture and current collectors, and to know the relationship between structural changes within the battery and the electrochemical performance of the battery, which may be determined by comprehensive computing.

According to an aspect of some embodiments of the invention, there is provided a method of manufacturing an electrochemical system which comprises at least one electrode (optionally a lithium-based electrode), the method comprising dispensing, in a configured pattern corresponding to the shape of the electrode, at least a first model composition (according to any of the respective embodiments described herein) which comprises at least one substance capable of reversibly releasing an electrochemically-active agent and/or at least one depleted form of a substance capable of reversibly releasing an electrochemically-active agent. Dispensing comprises heating a filament which comprises the first model composition, to thereby provide a dispensable form of the first composition (that is, a heated composition featuring rheological properties suitable for being dispensed through a nozzle and dispensing the dispensable, heated first composition (comprising the first model composition upon heating), optionally using any suitable means and/or technique of fused filament fabrication known in the art.

Herein, an “electrochemically-active agent” refers to an agent (comprising one or more atoms), optionally an ion, which affects a flow of electrons in a surrounding environment concomitantly with release and/or uptake of the agent by a substance described herein, e.g., by releasing and/or absorbing one or more electrons in a redox reaction, and/or by attracting and/or repelling one or more electrons (e.g., by electrostatic interaction). Optionally the agent is one used as an electrode material, e.g., in a battery known in the art.

Examples of suitable electrochemically active agents include, without limitation, metals (which may optionally be metal cations throughout reversible release described herein and/or atoms within a substance which are released from a substance as cations upon oxidation) and oxides and salts thereof, such as, e.g., copper, lead (optionally in a form of PbSO₄), nickel (optionally in a form of NiO(OH) or Ni(OH)₂), cadmium (optionally in a form of Cd(OH)₂), zinc (optionally in a form of ZnO or ZnSO₄), vanadium (optionally in a form of an oxide or salt thereof), magnesium, calcium, aluminum (optionally in a form of Al(OH)₃ or AlCl₄⁻), iron (optionally in a form of Fe(OH)₂), silver (optionally in a form of silver chloride or silver oxide), germanium, chromate, mercury, and alkali metals (e.g., lithium, sodium, potassium); and sulfur or sulfides (optionally S²⁻, S₂²⁻ or S₄²⁻).

Herein, the phrase “substance capable of reversibly releasing an electrochemically-active agent” refers to a substance as described herein, which encompasses a first form of the substance (e.g., an alloy and/or salt of the electrochemically-active agent) which has a relatively high content of the electrochemically-active agent, a second form of the substance (also referred to herein interchangeably as the “depleted” form) having a relatively low (optionally zero or close to zero, for example, less than 10% by molar concentration) content of the electrochemically-active agent (e.g., an alloy or salt having a low content of the electrochemically-active agent or a compound or element which forms an alloy or salt with the electrochemically-active agent), and all forms of the substance having an intermediate content of electrochemically-active agent.

The phrase “reversibly releasing” means that the first form of the substance is capable of releasing, or releases, the electrochemically-active agent until the second form of the substance is obtained; the second (depleted) form of the substance is capable of absorbing, or absorbs, electrochemically-active agent until the first form of the substance is re-obtained; and the re-obtained first form of the substance is capable of re-releasing, or re-releases, the electrochemically-active agent. Release and/or absorption of the electrochemically-active agent may involve oxidation and/or reduction of the electrochemically-active agent, e.g., conversion of a non-charged electrochemically-active agent to an ion upon release and vice versa upon absorption. The second form of the substance is typically characterized by a lower volume than the first form of the substance due to the loss of atoms via release of electrochemically-active agent. In some embodiments, the electrochemically-active agent undergoes release and absorption from the substance in the form of cations.

In some of any of the respective embodiments described herein, the substance is a substance capable of reversibly releasing an alkali metal and/or at least one form of a substance capable of reversibly releasing an alkali metal from which the alkali metal is absent.

In some of any of the respective embodiments described herein, the substance is a substance capable of reversibly releasing lithium and/or at least one delithiated form of a substance capable of reversibly releasing lithium.

An electrode comprising at least one substance capable of reversibly releasing lithium and/or a delithiated form thereof is also referred to herein interchangeably as a “lithium ion electrode” and/or “lithium-based electrode”.

### Substance Capable of Reversibly Releasing Lithium

For convenience, substances capable of reversibly releasing lithium are described in detail herein. However, for any of the embodiments described herein relating to lithium, the lithium may optionally be partially or entirely substituted by any other cation or cation-forming metal suitable for electrochemical systems such as described herein, optionally any alkali metal other than lithium (e.g., sodium).

Herein, the phrase “substance capable of reversibly releasing lithium” refers to a substance as described herein, which encompasses a first form of the substance (e.g., an alloy and/or salt of lithium) which has a relatively high lithium content, a second form of the substance (also referred to herein interchangeably as the “delithiated” form) having a relatively low (optionally zero or close to zero, for example, less than 10% by molar concentration) lithium content (e.g., an alloy or salt having a low lithium content or the compound or element which forms an alloy or salt with lithium), and all forms of the substance having an intermediate lithium content.

The amount of lithium which can be released and absorbed by a substance may be represented as the difference between an amount of lithium in the abovementioned first form of the substance and an amount of lithium in the abovementioned second form of the substance.

According to some embodiments of any one of the embodiments described herein, a concentration of lithium in the first form of the substance is greater than a concentration of lithium in the second (delithiated) form of the substance by at least 0.005 moles per cm³ (e.g., from 0.005 to 0.1 moles/cm³, or from 0.005 to 0.05 moles/cm³). In some embodiments, a concentration of lithium in the first form of the substance is greater than a concentration of lithium in the second form of the substance by at least 0.01 moles per cm³ (e.g., from 0.01 to 0.1 moles/cm³, or from 0.01 to 0.05 moles/cm³). In some embodiments, a concentration of lithium in the first form of the substance is greater than a concentration of lithium in the second form of the substance by at least 0.02 moles per cm³ (e.g., from 0.02 to 0.1 moles/cm³, or from 0.02 to 0.05 moles/cm³). In some embodiments, a concentration of lithium in the first form of the substance is greater than a concentration of lithium in the second form of the substance by at least 0.05 moles per cm³ (e.g., from 0.05 to 0.1 moles/cm³).

According to some embodiments of any one of the embodiments described herein, a weight percentage of lithium in the first form of the substance is greater than a weight percentage of lithium in the second (delithiated) form of the substance by at least 2% (e.g., from 2 to 70%, or from 2 to 30%, or from 2 to 10%), for example, wherein a weight percentage of lithium in the second form is no more than 1% and a weight percentage of lithium in the first form is at least 3% (e.g., from 3 to 70%, or from 3 to 30%, or from 3 to 10%). In some embodiments, a weight percentage of lithium in the first form of the substance is greater than a weight percentage of lithium in the second form of the substance by at least 5% (e.g., from 5 to 70%, or from 5 to 30%, or from 5 to 10%). In some embodiments, a weight percentage of lithium in the first form of the substance is greater than a weight percentage of lithium in the second form of the substance by at least 10% (e.g., from 10 to 70%, or from 10 to 30%). In some embodiments, a weight percentage of lithium in the first form of the substance is greater than a weight percentage of lithium in the second form of the substance by at least 20% (e.g., from 20 to 70%, or from 20 to 30%). In some embodiments, a weight percentage of lithium in the first form of the substance is greater than a weight percentage of lithium in the second form of the substance by at least 50% (e.g., from 50 to 70%).

According to some embodiments of any one of the embodiments described herein, a molar percentage of lithium the percentage of atoms which are atoms of lithium) in the first form of the substance is greater than a molar percentage of lithium in the second (delithiated) form of the substance by at least 20% (e.g., from 20 to 90%, or from 20 to 50%), for example, wherein a molar percentage of lithium in the second form is no more than 5% and a molar percentage of lithium in the first form is at least 25%. In some embodiments, a molar proportion of lithium in the first form of the substance is greater than a molar proportion of lithium in the second form of the substance by at least 30% (e.g., from 30 to 90%, or from 30 to 50%). In some embodiments, a molar proportion of lithium in the first form of the substance is greater than a molar proportion of lithium in the second form of the substance by at least 50% (e.g., from 50 to 90%). In some embodiments, a molar proportion of lithium in the first form of the substance is greater than a molar proportion of lithium in the second form of the substance by at least 75% (e.g., from 75 to 90%), for example, wherein a molar percentage of lithium in the second form is no more than 5% and a molar percentage of lithium in the first form is at least 80%.

Any substance that can incorporate variable amounts of lithium atoms is contemplated. In some embodiments, the substance is not carbon (e.g., graphite).

In some of any of the respective embodiments described herein, the substance capable of reversibly releasing lithium is a lithium metal oxide and/or a lithium metal sulfide (collective referred to herein for brevity as “oxide/sulfide”, which term is to be regarded as interchangeable with “oxide and/or sulfide”).

Herein, a “lithium metal oxide” refers to a compound (e.g., ceramic and/or salt) comprising (e.g., in stoichiometric amounts) at least one lithium atom, at least one metal atom other than lithium, and at least one oxygen atom.

Accordingly, a metal oxide is a delithiated form of a lithium metal oxide.

Optionally, the lithium metal oxide consists essentially of lithium, one or more metal other than lithium, and oxygen.

Alternatively or additionally, the lithium metal oxide and/or metal oxide (as defined herein) further comprises, for example, at least one additional species of atom (optionally covalently bound to the oxygen atom(s)) such as phosphorus and/or silicon, e.g., a lithium metal phosphate (e.g., lithium iron phosphate) and/or lithium metal silicate, or delithiated forms thereof.

Herein, a “lithium metal sulfide” refers to a compound (e.g., ceramic and/or salt) comprising (e.g., in stoichiometric amounts) at least one lithium atom, at least one metal atom other than lithium, and at least one sulfur atom. A sulfide according to any of the embodiments described herein may optionally correspond to an oxide according to any of the respective embodiments herein, wherein one or more (optionally all) of the oxygen atoms of the oxide are replaced by sulfur atoms.

Accordingly, a metal sulfide (as defined herein) is a delithiated form of a lithium metal sulfide.

Examples of suitable lithium metal oxides include, without limitation, lithium titanate (LTO; e.g., Li₄Ti₅O₁₂), lithium iron phosphate (LFP, e.g., LiFePO₄), lithium cobalt oxide (LCO; e.g., LiCoO₂), lithium manganese oxide (LMO; e.g., LiMn₂O₄), lithium nickel cobalt aluminum oxide (NCA; e.g., LiNiₓCo_{y}Al_{z}O₂, wherein x+y+z=1, and z is small, for example, less than 0.1), and lithium nickel manganese cobalt oxide (NMC; e.g., LiNiₓMn_{y}Co_{z}O₂, wherein x+y+z=1).

In any of the embodiments described herein relating to lithium metal oxide/sulfides, the metal oxide/sulfide may optionally be in a partially delithiated form (comprising less Li than a stoichiometry described herein) or in a delithiated form, being a metal oxide/sulfide capable of uptake of lithium ions to form a lithium metal oxide/sulfide (according to any of the respective embodiments described herein). Examples of such metal oxides include, without limitation, titanate (e.g., Ti₅O₁₂), iron phosphate (e.g., FePO₄), cobalt oxide (e.g., CoO₂), manganese oxide (e.g., Mn₂O₄), nickel cobalt aluminum oxide (e.g., NiₓCo_{y}Al_{z}O₂, wherein x+y+z=1, and z is small, for example, less than 0.1), and nickel manganese cobalt oxide (NMC; e.g., NiₓMn_{y}Co_{z}O₂, wherein x+y+z=1).

In some of any of the respective embodiments described herein, the substance capable of reversibly releasing lithium is a lithium alloy.

Herein, the term “alloy” refers to a mixture or solid solution composed of a metal (e.g., lithium) and one or more other elements, at any molar ratio of metal to the other element(s).

Herein, the term “lithium alloy” refers to an alloy (as defined herein) composed of lithium and one or more other elements. Preferably, the compound(s) or element(s) which forms an alloy with lithium is not another alkali metal. In some embodiments, the lithium alloy may comprise a single phase of lithium and the other element(s). The compound or element which forms an alloy with lithium may be an element or a mixture of elements (other than lithium).

Accordingly, a compound which forms an alloy with lithium is a delithiated form of a lithium alloy.

LTO (lithium titanate) and lithium alloys (and delithiated forms thereof) are non-limiting examples of substances suitable for use in an anode. LFP, LCO, LMO, NCA and NMC (and delithiated forms thereof) are non-limiting examples of substances suitable for use in a cathode.

Herein throughout, references to a “compound” are intended to encompass elements and mixtures of elements, unless explicitly indicated otherwise.

Herein, a compound “which forms an alloy” with lithium refers to a compound or element which exhibits the property of being capable of forming, or which forms, an alloy with lithium upon combination with lithium, as opposed, for example, to remaining in a separate phase from the lithium. Optionally, the alloy is characterized by a specific stoichiometric proportion of lithium atoms, e.g., according to any of the respective embodiments described herein. The skilled person will be readily capable of determining which compounds and elements form an alloy with lithium.

According to some embodiments of any one of the embodiments described herein, the compound which forms an alloy with lithium comprises (and optionally consists of) silicon, tin, antimony, germanium, lead, bismuth, magnesium, aluminum, and/or an alloy of any one or more of the aforementioned elements with any other element, including, for example, mixtures (e.g., alloys) of any two or more of the aforementioned elements). Silicon-nickel alloy is an example of a suitable silicon alloy. Antimony-manganese alloy is an example of a suitable antimony alloy. Tin-cobalt alloy is an example of a suitable tin alloy. Germanium-tin alloy is a suitable example of an alloy of two of the aforementioned elements.

In some embodiments of any one of the embodiments described herein, the lithium alloy may be described by the general formula LiₓA, wherein Li is lithium and A is an element which forms an alloy with lithium, for example, silicon, tin, antimony, germanium, lead, bismuth, and/or mixtures thereof. Examples of such alloys include, without limitation, alloys wherein A is silicon and x=4.2 (e.g., Li_{4.2}Si) or x=4.4 (e.g., Li_{4.4}Si), A is tin and x=4.4 (e.g., Li_{4.4}Sn), A is antimony and x=3 (e.g., Li₃Sb), A is germanium and x=4.4 (e.g., Li_{4.4}Ge), A is lead and x is about 0.2 (e.g., Li₁₇Pb₈₃), A is bismuth and x=3 (e.g., Li₃Bi), A is antimony-manganese and x is about 0.5 (e.g., Li_{32.2}Sb_{31.8}Mn₃₆), and wherein A is a germanium-tin alloy (e.g., Ge_{1-y}Sn_{y} wherein y=0.1-0.4).

It is expected that during the life of a patent maturing from this application many relevant substances capable of reversibly releasing lithium (e.g., lithium metal oxide/sulfides and lithium alloys) will be developed and the scope of the terms “substance capable of reversibly releasing lithium”, “lithium metal oxide/sulfide” and “lithium alloy” are intended to include all such respective new technologies a priori.

### Thermoplastic Polymer

The model compositions (e.g., first or second model compositions) and/or composite material described herein (e.g., a composite material formed using a model composition) according to any of the respective embodiments preferably comprises at least one thermoplastic material, optionally a thermoplastic polymer.

In optional embodiments, the polymer is biodegradable, i.e., is broken down by the action of living organisms (e.g., bacteria).

Examples of thermoplastic polymers (which may be used individually or in combination) suitable for use in any of the embodiments described herein relating to a thermoplastic polymer include, without limitation, acrylonitrile butadiene styrene, polylactic acid, polyethylene terephthalate, polycarbonates, polyamides, polyurethanes, polystyrene, polyvinyl alcohol, polyvinylpyrrolidone, polyacrylic acid (or a salt thereof), polymethyl methacrylate, polyvinylidene fluoride, polyvinylidene chloride, polyethylene, polyethylene oxide, carboxymethylcellulose (or a salt thereof) lignin and rubber. Polylactic acid is an exemplary thermoplastic polymer (which is also biodegradable).

In some of any of the respective embodiments described herein relating to a thermoplastic polymer, the substance capable of reversibly releasing lithium (according to any of the respective embodiments described herein) is in a form of particles dispersed in the polymer.

In some of any of the respective embodiments described herein, a concentration of thermoplastic polymer in the model compositions (e.g., first or second model compositions) and/or composite material (e.g., first or second composite material) is at least 20 weight percents. In some embodiment, the concentration of thermoplastic polymer is at least 25 weight percents. In some embodiment, the concentration of thermoplastic polymer is at least 30 weight percents. In some embodiment, the concentration of thermoplastic polymer is at least 35 weight percents. In some embodiment, the concentration of thermoplastic polymer is at least 40 weight percents.

### Model Compositions and Composite Materials

As described elsewhere herein, a first model composition used to prepare an electrode, and a first composite material of an electrode, comprise at least one substance capable of reversibly releasing lithium (according to any of the respective embodiments described herein), and optionally also a thermoplastic polymer (according to any of the respective embodiments described herein).

In some of any of the respective embodiments described herein, a total concentration of a substance capable of reversibly releasing lithium (and/or delithiated form thereof) in the model composition is at least about 5 weight percents. In some embodiments, a total concentration of a substance capable of reversibly releasing lithium (and/or delithiated form thereof) in the model composition is at least about 10 weight percents. In some embodiments, a total concentration of a substance capable of reversibly releasing lithium (and/or delithiated form thereof) in the model composition is at least about 20 weight percents. In some embodiments, a total concentration of a substance capable of reversibly releasing lithium (and/or delithiated form thereof) in the model composition is at least about 30 weight percents. In some embodiments, a total concentration of a substance capable of reversibly releasing lithium (and/or delithiated form thereof) in the model composition is at least about 40 weight percents. In some embodiments, a total concentration of a substance capable of reversibly releasing lithium (and/or delithiated form thereof) in the model composition is at least about 50 weight percents. In some of any of the aforementioned embodiments, the substance capable of reversibly releasing lithium is a lithium metal oxide/sulfide according to any of the respective embodiments described herein.

In some of any of the respective embodiments described herein, a total concentration of a substance capable of reversibly releasing lithium (and/or delithiated form thereof) in the model composition is no more than about 80 weight percents. In some such embodiments, the total concentration is in a range of from about 5 to about 80 weight percents. In some embodiments, the total concentration is in a range of from about 10 to about 80 weight percents. In some embodiments, the total concentration is in a range of from about 20 to about 80 weight percents. In some embodiments, the total concentration is in a range of from about 30 to about 80 weight percents. In some embodiments, the total concentration is in a range of from about 40 to about 80 weight percents. In some embodiments, the total concentration is in a range of from about 50 to about 80 weight percents (e.g., about 70 weight percents). In some of any of the aforementioned embodiments, the substance capable of reversibly releasing lithium is a lithium metal oxide/sulfide according to any of the respective embodiments described herein.

In some of any of the respective embodiments described herein, a total concentration of a substance capable of reversibly releasing lithium (and/or delithiated form thereof) in the model composition is no more than about 70 weight percents. In some such embodiments, the total concentration is in a range of from about 5 to about 70 weight percents. In some embodiments, the total concentration is in a range of from about 10 to about 70 weight percents. In some embodiments, the total concentration is in a range of from about 20 to about 70 weight percents. In some embodiments, the total concentration is in a range of from about 30 to about 70 weight percents. In some embodiments, the total concentration is in a range of from about 40 to about 70 weight percents. In some embodiments, the total concentration is in a range of from about 50 to about 70 weight percents (e.g., about 50 weight percents). In some of any of the aforementioned embodiments, the substance capable of reversibly releasing lithium is a lithium metal oxide/sulfide according to any of the respective embodiments described herein.

In some of any of the respective embodiments described herein, a total concentration of a substance capable of reversibly releasing lithium (and/or delithiated form thereof) in the model composition is no more than about 60 weight percents. In some such embodiments, the total concentration is in a range of from about 5 to about 60 weight percents. In some embodiments, the total concentration is in a range of from about 10 to about 60 weight percents. In some embodiments, the total concentration is in a range of from about 20 to about 60 weight percents. In some embodiments, the total concentration is in a range of from about 30 to about 60 weight percents. In some embodiments, the total concentration is in a range of from about 40 to about 60 weight percents (e.g., about 50 weight percents). In some of any of the aforementioned embodiments, the substance capable of reversibly releasing lithium is a lithium metal oxide/sulfide according to any of the respective embodiments described herein.

In some of any of the respective embodiments described herein, a total concentration of a substance capable of reversibly releasing lithium (and/or delithiated form thereof) in the model composition is no more than about 50 weight percents. In some such embodiments, the total concentration is in a range of from about 5 to about 50 weight percents. In some embodiments, the total concentration is in a range of from about 10 to about 50 weight percents. In some embodiments, the total concentration is in a range of from about 20 to about 50 weight percents. In some embodiments, the total concentration is in a range of from about 30 to about 50 weight percents (e.g., about 40 weight percents). In some of any of the aforementioned embodiments, the substance capable of reversibly releasing lithium is a lithium metal oxide/sulfide according to any of the respective embodiments described herein.

In some of any of the respective embodiments described herein, a total concentration of a substance capable of reversibly releasing lithium (and/or delithiated form thereof) in the model composition is no more than about 40 weight percents. In some such embodiments, the total concentration is in a range of from about 5 to about 40 weight percents. In some embodiments, the total concentration is in a range of from about 10 to about 40 weight percents. In some embodiments, the total concentration is in a range of from about 20 to about 40 weight percents (e.g., about 30 weight percents). In some of any of the aforementioned embodiments, the substance capable of reversibly releasing lithium is a lithium metal oxide/sulfide according to any of the respective embodiments described herein.

In some of any of the respective embodiments described herein, a total concentration of a substance capable of reversibly releasing lithium (and/or delithiated form thereof) in the model composition is no more than about 30 weight percents. In some such embodiments, the total concentration is in a range of from about 5 to about 30 weight percents. In some embodiments, the total concentration is in a range of from about 10 to about 30 weight percents (e.g., about 20 weight percents). In some of any of the aforementioned embodiments, the substance capable of reversibly releasing lithium is a lithium metal oxide/sulfide according to any of the respective embodiments described herein.

In some of any of the respective embodiments described herein, a concentration of thermoplastic polymer in a first model compositions and/or first composite material (according to any of the respective embodiments described herein) is no more than 60 weight percents, for example, from 20 to 60 weight percents, or from 25 to 60 weight percents, or from 30 to 60 weight percents, or from 35 to 60 weight percents, or from 40 to 60 weight percents. In some such embodiments, a concentration of a substance capable of reversibly releasing lithium is at least 20 weight percents (e.g., from 20 to 80 weight percents, or from 20 to 70 weight percents), according to any of the respective embodiments described herein. In some embodiments, a concentration of a substance capable of reversibly releasing lithium is at least 30 weight percents (e.g., from 30 to 80 weight percents, or from 30 to 70 weight percents), according to any of the respective embodiments described herein. In some embodiments, a concentration of a substance capable of reversibly releasing lithium is at least 40 weight percents (e.g., from 40 to 80 weight percents, or from 40 to 70 weight percents), according to any of the respective embodiments described herein.

In some of any of the respective embodiments described herein, a concentration of thermoplastic polymer in a first model compositions and/or first composite material (according to any of the respective embodiments described herein) is no more than 50 weight percents, for example, from 20 to 50 weight percents, or from 25 to 50 weight percents, or from 30 to 50 weight percents, or from 35 to 50 weight percents, or from 40 to 50 weight percents. In some such embodiments, a concentration of a substance capable of reversibly releasing lithium is at least 30 weight percents (e.g., from 30 to 80 weight percents, or from 30 to 70 weight percents), according to any of the respective embodiments described herein. In some embodiments, a concentration of a substance capable of reversibly releasing lithium is at least 40 weight percents (e.g., from 40 to 80 weight percents, or from 40 to 70 weight percents), according to any of the respective embodiments described herein. In some embodiments, a concentration of a substance capable of reversibly releasing lithium is at least 50 weight percents (e.g., from 50 to 80 weight percents, or from 50 to 70 weight percents), according to any of the respective embodiments described herein.

In some of any of the respective embodiments described herein, a concentration of thermoplastic polymer in a first model compositions and/or first composite material (according to any of the respective embodiments described herein) is no more than 40 weight percents, for example, from 20 to 40 weight percents, or from 25 to 40 weight percents, or from 30 to 40 weight percents. In some such embodiments, a concentration of a substance capable of reversibly releasing lithium is at least 40 weight percents (e.g., from 40 to 80 weight percents, or from 40 to 70 weight percents), according to any of the respective embodiments described herein. In some embodiments, a concentration of a substance capable of reversibly releasing lithium is at least 50 weight percents (e.g., from 50 to 80 weight percents, or from 50 to 70 weight percents), according to any of the respective embodiments described herein. In some embodiments, a concentration of a substance capable of reversibly releasing lithium is at least 60 weight percents (e.g., from 60 to 80 weight percents), according to any of the respective embodiments described herein.

In some of any of the respective embodiments described herein, a concentration of thermoplastic polymer in a first model compositions and/or first composite material (according to any of the respective embodiments described herein) is no more than 30 weight percents, for example, from 20 to 30 weight percents. In some such embodiments, a concentration of a substance capable of reversibly releasing lithium is at least 50 weight percents (e.g., from 50 to 80 weight percents, or from 50 to 70 weight percents), according to any of the respective embodiments described herein. In some embodiments, a concentration of a substance capable of reversibly releasing lithium is at least 60 weight percents (e.g., from 60 to 80 weight percents, or from 60 to 70 weight percents), according to any of the respective embodiments described herein. In some embodiments, a concentration of a substance capable of reversibly releasing lithium is at least 70 weight percents (e.g., from 70 to 80 weight percents), according to any of the respective embodiments described herein.

As described elsewhere herein, a second model composition (or second composite material) which comprises a conductive material may optionally be used, e.g., to prepare a current collector. The second model composition and/or second composite material according to any of the respective embodiments described herein optionally further comprise at least one thermoplastic material, optionally a thermoplastic polymer (e.g., a thermoplastic polymer according to any of the respective embodiments described herein).

Examples of suitable conductive materials include, without limitation, various metals and forms of carbon, such as graphite, graphene, carbon nanotubes (e.g., multi-walled carbon nanotubes) and/or amorphous carbon (e.g., carbon black), e.g., in particulate form. Graphene is an exemplary conductive material for inclusion in a second model composition.

Suitable compositions comprising a thermoplastic material (e.g., polymer) and conductive material, as well as suitable concentrations for a given conductive material, are known in the art.

In some of any of the respective embodiments, the second model composition (or second composite material) is substantially devoid of lithium.

In some of any of the respective embodiments described herein, a model composition (e.g., first and/or second model composition) and/or composite material (e.g., first and/or second composite material) comprises a polymer which is a lithium salt, that is, a salt of an anionic polymer (e.g., polyacrylic acid) and lithium cations.

Without being bound by any particular theory, it is believed that lithium salt polymers can provide a combination of lithium ion conductivity (due to the presence of lithium ions therein) and advantageous structural properties associated with polymers.

In some of any of the respective embodiments described herein, a model composition (e.g., first and/or second model composition) and/or composite material (e.g., first and/or second composite material) according to any of the respective embodiments described herein further comprises a plasticizer, e.g., in admixture with a thermoplastic polymer according to any of the respective embodiments described herein.

Herein, the term “plasticizer” refers to any additive which increases the plasticity and/or decreases the viscosity of the model composition and/or composite material, e.g., by modulating the plasticity and/or viscosity of a polymer in the model composition and/or composite material.

Examples of plasticizers include, without limitation, esters (e.g., C₁-C₁₀-alkyl esters) of aromatic or aliphatic dicarboxylic acids and tricarboxylic acids, such as phthalates (e.g., bis(2-ethylhexyl) phthalate, bis(2-propylheptyl) phthalate, diisononyl phthalate, di-n-butyl phthalate, butyl benzyl phthalate, diisodecyl phthalate, dioctyl phthalate, diisooctyl phthalate, diethyl phthalate), terephthalates (e.g., dioctyl terephthalate), trimellilates (e.g., trimethyl trimellilate, tri-(2-ethylhexyl) trimellilate), tri-(n-heptyl) trimellilate, tri-(n-octyl) trimellilate, tri-(n-nonyl) trimellilate, tri-(n-decyl) trimellilate), adipates (e.g., dimethyl adipate, monomethyl adipate, dioctyl adipate, bis(2-ethylhexyl) adipate), sebacates (e.g., dibutyl sebacate), azelates, maleates (e.g., dibutyl maleate, diisobutyl maleate), citrates (e.g., trimethyl citrate, triethyl citrate, acetyl triethyl citrate, tributyl citrate, acetyl tributyl citrate, trihexyl citrate, acetyl trihexyl citrate, butyryl trihexyl citrate, trioctyl citrate, acetyl trioctyl citrate) and 1,2-cyclohexane dicarboxylic acid (e.g., 1,2-cyclohexane dicarboxylic acid diisononyl ester); carbonate esters (e.g., propylene carbonate, ethylene carbonate); benzoates; sulfonamides, such as aryl sulfonamides (e.g., N-ethyl toluene sulfonamide, N-(2-hydroxypropyl) benzene sulfonamide, N-(n-butyl) benzene sulfonamides); organophosphate esters (e.g., tricresyl phosphate, tributyl phosphate); glycerol and glycols and esters thereof (e.g., triacetin, triethylene glycol dihexanoate, triethylene glycol diheptanoate); and polyethers (e.g., polyethylene glycol).

Polyethylene glycol (PEG) (e.g., low-molecular weight polyethylene glycol) is an exemplary plasticizer (e.g., for use in combination with polylactic acid).

Low-molecular weight polyethylene glycol according to any of the respective embodiments described herein (e.g., for use as a plasticizer) optionally has an average molecular weight of about 3,000 Da or less (e.g., from about 250 to about 3,000 Da, or from about 500 Da to about 3,000 Da, or from about 1,000 to about 3,000 Da), and optionally about 2,000 Da or less (e.g., from about 250 to about 2,000 Da, or from about 500 Da to about 2,000 Da, or from about 1,000 Da to about 2,000 Da).

In some of any of the respective embodiments described herein, the thermoplastic polymer comprises polylactic acid and the plasticizer comprises glycerol or an ester thereof (e.g., triacetin), a citrate ester (e.g., acetyl tributyl citrate), a carbonate ester (e.g., propylene carbonate), and low molecular weight PEG.

In some of any of the respective embodiments, a concentration of plasticizer in a model composition (e.g., first and/or second model composition) and/or composite material (e.g., first and/or second composite material) according to any of the respective embodiments described herein is at least 0.1 weight percent, for example from 0.1 to 10 weight percent, or from 0.1 to 3 weight percent. In some embodiments, a concentration of plasticizer is at least 0.3 weight percent, for example from 0.3 to 10 weight percent, or from 0.3 to 3 weight percent. In some embodiments, a concentration of plasticizer is at least 1 weight percent, for example from 1 to 10 weight percent, or from 1 to 3 weight percent.

In some of any of the respective embodiments, a model composition (e.g., first and/or second model composition) and/or composite material (e.g., first and/or second composite material) according to any of the respective embodiments described herein further comprises conductive particles, which are capable of conducting lithium ions and/or electrons. Conductive particles may comprise, for example, a metal and/or carbon. In exemplary embodiments the conductive particles comprise carbon.

Examples of suitable carbon particles (e.g., powder) include, without limitation, graphite, graphene, carbon nanotubes (e.g., multi-walled carbon nanotubes, optionally functionalized with carboxylic acid groups) and amorphous carbon (e.g., carbon black). Graphite, carbon nanotubes and carbon black are exemplary forms of carbon particles suitable for inclusion in model composition and/or composite material.

Without being bound by any particular theory, it is believed that conductive particles incorporated into a model composition (e.g., first model composition) described herein can provide sufficient conductivity (e.g., electron conductivity) for efficient use in electrodes. It is further believed that lithium ion conductivity of the composite polymer electrode, due to ability of lithium ions to diffuse through the polymer (e.g., due to porosity) and/or via ion conductivity of a substance capable of reversibly releasing lithium (or delithiated form thereof), interacts with electron conductivity to provide electric conductivity (via movement of both lithium ions and electrons).

The weight ratio of (total) conductive (e.g., carbon) particles to (total) substance capable of reversibly releasing lithium (or delithiated form thereof) in a model composition and/or composite material (according to any of the respective embodiments described herein) is optionally within a range of from 10:1 to 1:10, optionally from 3:1 to 1:3, optionally from 2:1 to 1:2, and optionally from 1.5:1 to 1:1.5. In exemplary embodiments the weight ratio is about 1:1.

It is to be appreciated that references herein to a first or second model composition and/or to a first or second composite material in the singular is not intended to be limiting. For example, each first or second model composition and/or to a first or second composite material may optionally comprise a plurality of different compositions/materials, e.g., according to different embodiments described herein regarding the respective model composition and/or composite material. In some embodiments, one first model composition and/or first composite material is suitable for one type of electrode (e.g., cathode), and another first model composition and/or first composite material is suitable for another type of electrode (e.g., anode).

Model compositions described herein are preferably characterized by melting and/or softening (to a degree sufficient to allow dispensing of the composition upon heating of a filament) at a temperature which does not harm an active material therein—e.g., by substantially reducing electrochemical activity of an active material in an irreversible manner (e.g., such that activity does not return upon cooling)—or degrade a polymer therein (e.g., by oxidation, pyrolysis or evaporation). The melted and/or softened model composition preferably retains sufficient viscosity to maintain a three dimensional shape and retain electrochemically active materials (e.g., a lithium metal oxide/phosphate/sulfide/silicate) therein, until the dispensed composition hardens (e.g., upon cooling). Such properties (e.g., viscosity at various temperatures) of a model composition may be affected in a controllable manner by properties such as the melting point and/or glass transition point of a thermoplastic polymer, the viscosity of a softened polymer, a plasticizer and amount thereof (generally correlating with reduced viscosity), and amount of solid material (e.g., electrochemically active material) dispersed in the composition (generally correlating with increased viscosity).

### Electrolyte

In any of the embodiments described herein relating to a model composition and/or composite material comprising a thermoplastic material (e.g., polymer), the lithium ion conductivity is optionally enhanced by contact of the material with an electrolyte, e.g., an electrolyte absorbed by the thermoplastic material (e.g., polymer) upon contact (e.g., by swelling of a polymer upon contact with a suitable solvent). Such contact of the material with an electrolyte may be effected prior to, concurrently with, and/or subsequently to dispensing of a composition according to any of the respective embodiments described herein.

In some of any of embodiments described herein relating to an electrolyte, the electrolyte comprises at least one compound comprising lithium ions. The compound(s) may optionally comprise a lithium salt (e.g., comprising lithium and an anion such as bis(trifluoromethylsulfonyl)imide (“bistriflimide”), tetrafluoroborate, hexafluorophosphate and/or halide) and/or a ceramic comprising lithium ions (e.g., LAGP (Li_{1.5}Al_{0.5}Ge_{1.5}P₃O₁₂) or LLZO (Li₇La₃Zr₂O₁₂) garnet).

In some of any of embodiments described herein relating to an electrolyte, the electrolyte is in a form of a liquid comprising the electrolyte, optionally an electrolyte solution.

According to some embodiments of any one of the embodiments described herein, the liquid comprising an electrolyte comprises an ionic liquid (e.g., pyridine and/or pyrrolidinium cations), for example, an ionic liquid known in the art to be suitable for a lithium ion battery. The ionic liquid may optionally comprise a cation such as a 1,3-dialkylimidazolium (e.g., 1-ethyl-3-methylimidazolium, 1-butyl-3-methylimidazolium and/or 1-hexyl-3-methylimidazolium), a 1,2,3-trialkylimidazolium (e.g., 1-butyl-2,3-dimethylimidazolium), a 1,3-dialkylpyrimidinium, an N-alkylpyridinium (e.g., N-octylpyridinium), an N-alkylisoquinolinium, an N-alkylpyrrolium, an N,N-dialkylpyrrolidinium (e.g., 1-methyl-1-propylpyrrolidinium, 1-methyl-1-butylpyrrolidinium and/or 1-methyl-1-octylpyrrolidinium), and N,N-dialkylpiperidinium (e.g., 1-methyl-1-propylpiperidinium, 1-methyl-1-butylpiperidinium and/or 1-methyl-1-octylpiperidinium); and/or an anion such as bistriflimide, tetrafluoroborate, hexafluorophosphate and/or halide; and/or any combinations thereof.

Examples of ionic liquids suitable for an lithium ion electrode (e.g., in a lithium ion battery or capacitor) include, without limitation, 1-ethyl-3-methylimidazolium salts; 1-butyl-3-methylimidazolium salts; 1-hexyl-3-methylimidazolium salts; 1-butyl-2,3-dimethylimidazolium salts; N-octylpyridinium salts; N-butyl-4-methylpyridinium salts; 1-methyl-1-propylpyrrolidinium ([MPPyrro]⁺) salts; 1-methyl-1-butylpyrrolidinium ([MBPyrro]⁺) salts, such as 1-methyl-1-butylpyrrolidinium bistriflimide; 1-methyl-1-propylpiperidinium ([MPPip]⁺) salts; 1-methyl-1-butylpiperidinium ([MBPip]⁺) salts; 1-methyl-1-octylpyrrolidinium ([MOPyrro]⁺) salts; and 1-methyl-1-octylpiperidinium ([MOPip]³⁰ ) salts.

In some of any of embodiments described herein relating to an electrolyte, at least a portion of the electrolyte is a solid electrolyte, optionally a porous solid. A solid electrolyte may optionally comprise a liquid comprising an electrolyte (according to any of the embodiments described herein) incorporated in the solid.

In some of any of the respective embodiments, the electrolyte is in a form of a membrane, optionally comprising a solid material (e.g., a thermoplastic polymer according to any of the respective embodiments described herein) and a liquid (e.g., a liquid comprising an electrolyte according to any of the embodiments described herein) incorporated in the solid (e.g., as a quasi-solid and/or swollen membrane).

Polylactic acid and polyethylene oxide are non-limiting examples of suitable thermoplastic polymers for forming a solid electrolyte, for example, in the form of a membrane. The polyethylene oxide may optionally comprise low molecular weight polyethylene glycol having a molecular weight of 3,000 Da or less (e.g., according to any of the respective embodiments described herein relating to low molecular weight polyethylene glycol).

Herein throughout, the terms “polyethylene glycol”, “PEO”, “polyethylene oxide” and “PEG” are used interchangeably, and each encompass a polymer of any molecular weight. In some passages herein, low molecular weight forms are referred to herein as “polyethylene glycol” and higher molecular weight forms are referred to as polyethylene oxide”, but such usage is merely for convenience, and is not intended to be limiting.

Without being bound by any particular theory, it is believed that for any given components such as described herein, a substance capable of reversibly releasing lithium and/or concentration thereof can be selected to provide enhanced lithium ion conductivity to a composite material described herein, via lithium ion conductivity of the substance and/or by forming gaps (e.g., enhancing porosity) in a thermoplastic polymer which facilitate lithium ion diffusion.

### The Method

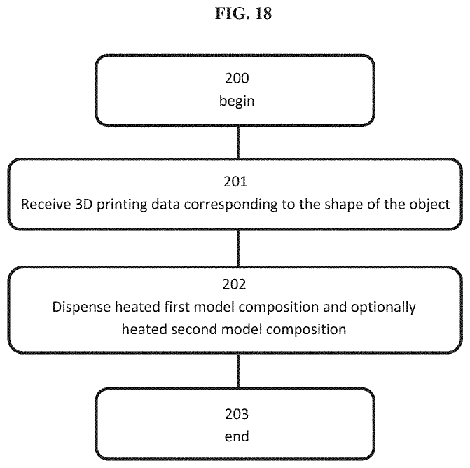

FIG. 18 presents a flowchart describing an exemplary method according to some embodiments of the present invention.

It is to be understood that, unless otherwise defined, the operations described herein below can be executed either contemporaneously or sequentially in many combinations or orders of execution. Specifically, the ordering of the flowchart diagrams is not to be considered as limiting. For example, two or more operations, appearing in the following description or in the flowchart diagrams in a particular order, can be executed in a different order (e.g., a reverse order) or substantially contemporaneously. Additionally, several operations described below are optional and may not be executed.

Computer programs implementing the method of the present embodiments can commonly be distributed to users on a distribution medium such as, but not limited to, a floppy disk, a CD-ROM, a flash memory device and a portable hard drive. From the distribution medium, the computer programs can be copied to a hard disk or a similar intermediate storage medium. The computer programs can be run by loading the computer instructions either from their distribution medium or their intermediate storage medium into the execution memory of the computer, configuring the computer to act in accordance with the method of this invention. All these operations are well-known to those skilled in the art of computer systems.

The computer implemented method of the present embodiments can be embodied in many forms. For example, it can be embodied in on a tangible medium such as a computer for performing the method operations. It can be embodied on a computer readable medium, comprising computer readable instructions for carrying out the method operations. In can also be embodied in electronic device having digital computer capabilities arranged to run the computer program on the tangible medium or execute the instruction on a computer readable medium.

The method begins at 200 and optionally and preferably continues to 201 at which computer object data (e.g., 3D printing data) corresponding to the shape of the object are received. The data can be received, for example, from a host computer which transmits digital data pertaining to fabrication instructions based on computer object data, e.g., in a form of STL, SLC format, VRML, AMF format, DXF, PLY or any other format suitable for CAD.

The method continues to 202 at which a first model composition and optionally a second and/or third model composition (according to any of the respective embodiments described herein) are dispensed upon being heated (e.g., a molten or semi-molten composition), optionally in layers, on a receiving medium, according to the computer object data (e.g., printing data), and as described herein. In some embodiments, a plurality of filaments (of one or more type) comprising one or more model compositions is heated.

In any of the embodiments described herein the dispensing is by one or more extruders. An extruder for dispensing model composition(s) optionally comprises a “cold end” configured for receiving a filament prior to heating (optionally from a spool), a mechanism (e.g., roller) for moving the received filament through the extruder, a mechanism for heating the filament (e.g., a heating chamber), and a nozzle through which the heated filament is extruded, optionally having a diameter of from about 0.3 mm to about 1.0 mm.

The receiving medium can be a tray (e.g., of a fused filament fabrication system) or a previously deposited layer.

In some embodiments of the invention, each type of filament (e.g., filaments differing in the model composition comprised therein) is dispensed from a different dispensing head of a printing apparatus. The different model compositions are optionally deposited in layers during the same pass of the printing heads. The model compositions and/or combination of compositions within the layer are selected according to the desired properties of the object, as described herein.

Optionally, before being dispensed, the filament, or a part thereof (e.g., one or more compositions of the building material), is heated, prior to being dispensed. The heating of the composition(s) is preferably to a temperature that allows fusion and/or dispensing of the respective composition through a nozzle of an extruder. In some embodiments of the present invention, the heating is to a temperature at which the respective composition exhibits a suitable viscosity as described herein in any of the respective embodiments.

In some of any of the embodiments described herein, the heating of the filament is to a temperature of at least about 100° C., at least about 150° C., at least about 175° C., or at least about 190° C. 190-210° C. is an exemplary temperature range (e.g., for polylactic acid-comprising filaments).

In some of any of the embodiments described herein, the heating of the filament is to a temperature of no more than about 300° C., no more than about 250° C., no more than about 225° C., or no more than about 210° C.

The filament(s) can be contained in a particular container of a solid freeform fabrication apparatus or a combination of filaments deposited from different containers of the apparatus.

In some embodiments, at least one, or at least a few (e.g., at least 10, at least 20, at least 30 at least 40, at least 50, at least 60, at least 80, or more), or all, of the layers is/are formed by dispensing filaments of a single model composition, as described herein in any of the respective embodiments.

In some embodiments, at least one, or at least a few (e.g., at least 10, at least 20, at least 30 at least 40, at least 50, at least 60, at least 80, or more), or all, of the layers is/are formed by dispensing different types of filaments comprising two or more model compositions, as described herein in any of the respective embodiments, each from a different dispensing head (e.g., extruder).

The method ends at 203.

According to some embodiments of any of the embodiments described herein, forming a configured pattern (e.g., associated with a three-dimensional electrode) comprises sequentially forming a plurality of layers. Preferably, forming of at least a few of the plurality of layers comprises dispensing a first model composition according to any of the respective embodiments described herein. At least some of the layers may optionally be different from one another, e.g., to thereby form a three-dimensional electrode. Alternatively, the layers may optionally all be substantially the same, e.g., thereby forming a three-dimensional object with a constant cross-section along the axis perpendicular to the layers.

According to some embodiments of any of the embodiments described herein, the electrochemical system further comprises a current collector which comprises an electrically conductive material, the current collector being in physical contact with at least a portion of an electrode. In some embodiments, the method of manufacturing the system further comprises dispensing a second model composition which comprises the conductive material, wherein dispensing the first and second model compositions is in a configured pattern corresponding to the shape of the electrochemical system, including the shape of the electrode and current collector.

In some of any of the respective embodiments, dispensing the second model composition comprises heating a filament comprising the second model composition to obtain a heated second model composition and dispensing the heated second model composition, e.g., according to procedures as described herein with respect to dispensing the first model composition.

In any of the embodiments relating to fused filament fabrication with a second model composition, the fused filament fabrication may optionally be effected using a filament comprising the second model composition (comprising conductive material) in addition to a (different) filament comprising the first model composition (comprising a substance capable of reversibly releasing lithium or delithiated form thereof).

Alternatively or additionally, a filament used to dispense a model composition may optionally comprise both the first model composition and the second model composition. In some embodiments, such a filament is characterized by a cross-section (i.e., perpendicular to the filament long axis) which comprises (in cross-section) both the first and second model compositions in a predetermined pattern, for example, a core-shell structure, e.g., wherein the cross-section comprises a first model composition (comprising a substance capable of reversibly releasing lithium or delithiated form thereof) surrounding a second model composition (comprising a conductive material of a current collector). Non-limiting exemplary cross-sections of core-shell structures for filaments are described in Example 1 and/or presented in FIG. 3 herein.

According to some of any of the respective embodiments described herein, the configured pattern is such that the electrode and current collector interlock with one another (e.g., as described herein). The interlocking may be determined by a pattern in which first and second model compositions are dispensed and/or by a structure of an individual filament comprising both the first model composition and second model composition (e.g., a core-shell structure according to any of the respective embodiments described herein).

According to some of any of the respective embodiments described herein, the method comprises manufacturing (e.g., by dispensing one or more model compositions according to any of the respective embodiments described herein) at least two lithium ion electrodes (e.g., including an anode and a cathode), each of the electrodes being independently formed in a respective configured pattern. The at least two electrodes may optionally be prepared from the same type of first model composition (e.g., to form a plurality of cathodes or a plurality of anodes) or different types of first model composition (e.g., different substances capable of reversibly releasing lithium and/or different concentrations thereof, and/or different thermoplastic polymers), for example, to form electrodes with different functions (e.g., a cathode and an anode).

The respective configured patterns may optionally be such that at least two of the electrodes are interlaced or intertwined with one another (i.e., cannot be separated without deformation), for example, without touching one another. In embodiments wherein the electrodes comprise a cathode and an anode, it is typically highly desirable that they do not contact each other. In some embodiments, at least one of (and optionally each of) the interlaced electrodes is in contact with a current collector (e.g., an interlocking current collector) according to any of the embodiments described herein relating to a current collector.

As exemplified herein, interlacing configured patterns for electrodes allows for a large degree of electrode surface area to be separated from an opposite electrode by a small distance (e.g., via a solid electrolyte, which is optionally in a form of a membrane), which can enhance efficiency.

According to some of any of the respective embodiments described herein, the method further comprises forming a layer of a solid material (e.g., solid electrolyte) or liquid material (e.g., electrolyte solution and/or ionic liquid) comprising an electrolyte on a surface of at least one electrode (e.g., between two electrodes). The electrolyte is optionally in a form of a membrane, according to any of the respective embodiments described herein. The material is optionally a porous solid comprising electrolyte (e.g., in solution) in pores thereof and/or a swollen solid comprising electrolyte (e.g., in solution) absorbed by the solid.

The electrolyte (e.g., solid electrolyte) according to any of the respective embodiments described herein may optionally be formed by dispensing a third model composition which comprises the electrolyte (e.g., by heating a filament, according to procedures such as described for a first model composition) in a configured pattern corresponding to the shape of the electrolyte. In some such embodiments, the third model composition comprises a thermoplastic polymer (according to any of the respective embodiments described herein) and at least one compounds comprising lithium ions (according to any of the respective embodiments described herein), such as a salt or ceramic.

The third model composition according to any of the respective embodiments is optionally dispensed concurrently with the dispensing of the first model composition and/or second model composition, that is, dispensing the third model composition begins after dispensing the first and/or second model composition begins and before dispensing the first and/or second model composition is completed, or dispensing the first and/or second model composition begins after dispensing the third model composition begins and before dispensing the third model composition is completed. Dispensing the first, second and/or third model compositions may optionally be effected in alternating steps.

Alternatively or additionally, the electrolyte in the electrochemical system is introduced by contacting electrodes with the material (e.g., an ionic liquid or electrolyte solution).

The electrolyte material may be any suitable electrolyte known in the art and/or in a form of any suitable electrolyte-containing material known in the art. Non-limiting examples of electrolytes (including electrolytes printable by dispensing a third model formulation upon heating of a filament) are described elsewhere herein.

Fused filament fabrication may optionally be utilized to dispense heated model composition(s) according to any of the respective embodiments described herein, and may be effected using any suitable technique and/or device known in the art. The embodiments described herein are not intended to be limiting.

It is expected that during the life of a patent maturing from this application many relevant fused filament fabrication techniques and devices will be developed and the scope of the term “fused filament fabrication” is intended to include all such new technologies a priori.

Embodiments described herein provide, inter alia, the ability to select materials from a given number of materials and define desired combinations of the selected materials and their properties. According to the present embodiments, the spatial locations of the deposition of each material with the layer is defined, either to effect occupation of different three-dimensional spatial locations by different materials, or to effect occupation of substantially the same three-dimensional location or adjacent three-dimensional locations by two or more different materials so as to allow post deposition spatial combination of the materials within the layer, thereby to form a composite material at the respective location or locations.

Any post-deposition combination or mix of modeling materials is contemplated. For example, once a certain material is dispensed it may preserve its original properties. However, when it is dispensed simultaneously with another modeling material or other dispensed materials which are dispensed at the same or nearby locations, a composite material having a different property or properties to the dispensed materials is formed.

Some of the embodiments thus enable the deposition of a broad range of material combinations, and the fabrication of an object which may consist of multiple different combinations of materials, in different parts of the object, according to the properties desired to characterize each part of the object.

In some of these embodiments, the two or more model compositions are dispensed in a voxelated manner, wherein voxels of one of said model compositions are interlaced with voxels of at least one another model composition.

Some optional embodiments thus provide a method of layer-wise fabrication of a three-dimensional object, in which for each of at least a few (e.g., at least two or at least three or at least 10 or at least 20 or at least 40 or at least 80) of the layers or all the layers, two or more model compositions are dispensed. Each model composition is preferably dispensed by extrusion, e.g., through one or more nozzle of a printing head. The dispensing is in a voxelated manner, wherein voxels of one of said model composition is interlaced with voxels of at least one another model composition, according to a predetermined voxel ratio.

Such a combination of two or more model compositions at a predetermined voxel ratio is referred to as digital material (DM).

The phrase “digital materials”, abbreviated as “DM”, as used herein and in the art, describes a combination of two or more materials on a microscopic scale or voxel level such that the printed zones of a specific material are at the level of few voxels, or at a level of a voxel block. Such digital materials may exhibit new properties that are affected by the selection of types of materials and/or the ratio and relative spatial distribution of two or more materials.

In exemplary digital materials, the modeling material of each voxel or voxel block, obtained upon curing, is independent of the modeling material of a neighboring voxel or voxel block, obtained upon curing, such that each voxel or voxel block may result in a different model material and the new properties of the whole part are a result of a spatial combination, on the voxel level, of several different model materials.

Herein throughout, whenever the expression “at the voxel level” is used in the context of a different material and/or properties, it is meant to include differences between voxel blocks, as well as differences between voxels or groups of few voxels. In preferred embodiments, the properties of the whole part are a result of a spatial combination, on the voxel block level, of several different modeling materials.

In some embodiments, where the building material comprises also support material formulation(s), the method proceeds to removing the hardened support material (e.g., thereby exposing the adjacent hardened modeling material). This can be performed by mechanical and/or chemical means, as would be recognized by any person skilled in the art.

### Electrochemical System

According to an aspect of some embodiments of the invention, there is provided an electrochemical system manufactured according to the method described herein, according to any of the respective embodiments.

According to an aspect of some embodiments of the invention, there is provided an electrochemical system which comprises at least one electrode, the electrode comprising a composite material (referred to herein as a “first composite material”), the composite material comprising a thermoplastic polymer (according to any of the respective embodiments described herein) and at least one substance capable of reversibly releasing an electrochemically-active agent (optionally an alkali metal such as lithium) or depleted form thereof (according to any of the respective embodiments described herein).

According to an aspect of some embodiments of the invention, there is provided an electrochemical system which comprises at least one lithium-based electrode, the electrode comprising a composite material (referred to herein as a “first composite material”), the composite material comprising a thermoplastic polymer (according to any of the respective embodiments described herein) and at least one substance capable of reversibly releasing lithium or delithiated form thereof (according to any of the respective embodiments described herein).

Herein, the term “electrochemical system” encompasses systems having a functionality associated with an electrochemical reaction (e.g., transfer of lithium ions and/or electrons) as well as systems which exhibit such a functionality only upon some pre-treatment, for example, addition of an electrolyte (e.g., liquid electrolyte) and/or additional component (e.g., an additional electrode or current collector).

The electrochemical system and/or first composite material therein optionally further comprise additional components (e.g., conducting particles, plasticizer(s) and/or electrolytes) according to any of the embodiments described herein (e.g., in the respective section herein).

A lithium-based electrode according to any of the respective embodiments described herein is optionally a three-dimensional electrode, that is, the shape of the electrode cannot be fully represented by a two-dimensional pattern (e.g., a two-dimensional cross-section which is constant along a particular axis).

In some of any of the respective embodiments, the substance capable of reversibly releasing lithium is a lithium metal oxide/sulfide according to any of the respective embodiments described herein, such that the electrode comprises a lithium metal oxide/sulfide and/or delithiated form thereof (metal oxide/sulfide).

In some of any of the respective embodiments, the substance capable of reversibly releasing lithium is a lithium alloy according to any of the respective embodiments described herein, such that the electrode comprises a lithium alloy and/or delithiated form thereof (compound which forms an alloy with lithium).

According some of any of the respective embodiments, the electrochemical system further comprises a current collector comprising a conductive material (according to any of the respective embodiments described herein), the current collector being in physical contact with at least a portion of the electrode, for example, with the composite material therein. The current collector and electrode optionally interlock with one another.

Herein throughout, a “current collector” refers to an electrically conductive material configured for mediating current (e.g., in the form of electrons) between various portions of an electrode and an electrical contact, optionally a single electrical contact. For example, a current collector may have a branched structure in the vicinity of an electrode, reaching over a considerable area of an electrode (while occupying only a fraction of the volume adjacent to the electrode) with a high ratio of surface area to current collector volume, connected to a centralized structure (e.g., a single wire) in the vicinity of an electrical contact.

Herein, two objects (e.g., electrode and current collector) are considered to “interlock” with one another when there exists at least one plane in which the shapes of the object are geometrically capable (i.e., in the absence of deformation) of being separated or sliding past one another by movement in no more than one direction in said plane, and optionally not at all (i.e., in zero directions in said plane). Optionally, the interlocked objects are geometrically incapable (i.e., in the absence of deformation) of being separated or sliding past one by movement in any direction (in any plane).

According to some of any of the respective embodiments described herein, the shapes of the electrode and current collector are tessellated, that is, there are substantially no gaps between the two shapes.

Interlocked, interdigitated and/or tessellated shapes are optionally selected so as to enhance the area of contact between the electrode material (e.g., substance capable or reversibly releasing lithium) and current collector, and/or to reduce the average distance between a random point in the electrode and the current collector.

In some of any of the respective embodiments, the current collector comprises a second composite material which comprising a thermoplastic polymer (according to any of the respective embodiments described herein) and conductive material (according to any of the respective embodiments described herein).

The first and/or second composite material is optionally formed, respectively, from a first and/or second model composition (according to any of the respective embodiments described herein), for example, upon cooling (by active cooling or simple exposure to ambient temperature) of a respective model composition heated in the course of a method manufacturing (e.g., as described herein) or otherwise having a solidified composition. The first and/or second composite material is optionally substantially identical, respectively, to a first and/or second model composition according to any of the respective embodiments described herein, for example, differing (if at all) only in temperature-sensitive properties such as rheological properties (e.g., hardening upon cooling of a model composition).

According some of any of the respective embodiments, the electrochemical system comprises at least two electrodes, each independently comprising a thermoplastic polymer and at least one substance capable of reversibly releasing lithium or delithiated form thereof (according to any of the respective embodiments described herein), for example, wherein at least two of the electrodes are interlaced electrodes. The plurality of electrodes (or portion thereof) are optionally separated from one another, e.g., by a solid or liquid material comprising an electrolyte (e.g., a solid electrolyte) according to any of the respective embodiments described herein. In some embodiments, the electrochemical system comprises an electrolyte (e.g., solid electrolyte) according to any of the respective embodiments described herein. In some embodiments, the electrochemical system is intended for use by contact with an electrolyte (e.g., immersion in a liquid comprising an electrolyte) according to any of the respective embodiments described herein.

In some of any of the embodiments comprising at least two separate electrodes with a substance capable of reversibly releasing lithium or delithiated form thereof, at least one electrode comprises a substance (e.g., in a first composite material therein) suitable for an anode (e.g., LTO and/or lithium alloy, and delithiated forms thereof), and at least one electrode comprises a substance (e.g., in a first composite material therein) suitable for a cathode (e.g., LFP, LCO, LMO, NCA and/or NMC, and delithiated forms thereof).

According to some of any of the respective embodiments, the electrochemical system comprises an electrochemical half-cell which comprises an electrode (optionally an electrode in combination with a current collector) and an electrolyte, according to any of the respective embodiments described herein.

In some embodiments according to any of the embodiments described herein relating to an electrochemical system and/or half-cell comprising an electrolyte, the system and/or half-cell comprises a liquid which comprises an electrolyte (e.g., according to any of the respective embodiments described herein). In some embodiments, the system and/or half-cell comprises a solid electrolyte (e.g., according to any of the respective embodiments described herein).

In some embodiments, the electrode of the half-cell is a cathode. Any of the embodiments described herein comprising a lithium metal oxide/sulfide (or delithiated form thereof) may optionally serve as a cathode, e.g., in the presence of a suitable lithium ion anode, for example, a lithium metal anode (i.e., comprising metallic lithium), a lithium titanate anode, a lithium alloy anode (e.g., a silicon, silicon/nickel or tin/cobalt alloy), or carbon (e.g., graphite) anode). An aforementioned anode (e.g., lithium titanate or lithium alloy anode) may optionally, but not necessarily be a component of an electrochemical system described herein and/or prepared in accordance with a method described herein. For example, the electrochemical system may be configured for use in combination with a suitable anode.

In some embodiments, the electrode of the half-cell is an anode. Lithium titanate (LTO) and lithium alloys (and delithiated forms thereof) are non-limiting examples of a substance capable of reversibly releasing lithium suitable for use in combination with a suitable lithium ion cathode. For example, LTO may optionally be used in combination with a cathode comprising another lithium metal oxide/sulfide described herein, and a lithium alloy may optionally be used in combination with a cathode comprising any lithium metal oxide/sulfide. An aforementioned cathode comprising a lithium metal oxide/sulfide (e.g., LTO, LFP, LCO, LMO, NCA and/or NMC) may optionally, but not necessarily, be a component of an electrochemical system described herein and/or prepared in accordance with a method described herein. For example, the electrochemical system may be configured for use in combination with a suitable cathode.

According to an aspect of some embodiments of the invention, there is provided a battery (e.g., a rechargeable battery) and/or a capacitor (e.g., supercapacitor) comprising at least one electrochemical system according to any of the respective embodiments described herein, for example, a system comprising at least one half-cell according to any of the respective embodiments described herein.

According to some of any of the respective embodiments, the lithium ion battery and/or capacitor (e.g., supercapacitor) comprise an electrochemical system which comprises at least two electrodes (optionally interlacing electrodes), according to any of the respective embodiments described herein, and an electrolyte (e.g., according to any of the respective embodiments described herein).

Herein, the phrase “lithium ion battery” encompasses any source of electrical power which comprises one or more electrochemical cells, in which electrical power generation is associated with transfer of lithium ions from one electrode to another.

Herein, the phrase “capacitor” refers to a device configured for storing electrical energy in an electric field.

Herein, the phrase “supercapacitor” refers to a capacitor in which energy is stored as electrostatic double-layer capacitance (e.g., in which a double layer—parallel charged layers—is formed at an interface between a surface of an electrode and an electrolyte) and/or as electrical pseudocapacitance (e.g., wherein energy is stored by charge transfer between electrode and electrolyte, by electrosorption, intercalation, oxidation and/or reduction reactions). In general, capacitors utilizing lithium ions for charge transfer (according to any of the respective embodiments described herein) are typically recognized in the art as supercapacitors.

In some of any of the respective embodiments, the lithium ion battery comprises an electrochemical system (e.g., comprising a suitable half-cell) according to any of the respective embodiments of the invention as a cathode, as well as a lithium ion anode of any type known in the art, for example, a lithium metal anode, a lithium alloy anode (e.g., a silicon or tin/cobalt alloy), or carbon (e.g., graphite) anode).

In some of any of the respective embodiments, the lithium ion battery comprises an electrochemical system (e.g., comprising a suitable half-cell) according to any of the respective embodiments of the invention as an anode (e.g., an electrochemical half-cell described herein comprising LTO and/or lithium alloy), as well as a lithium ion cathode of any type known in the art. For example, LTO may optionally be used in combination with another lithium metal oxide/sulfide described herein, and a lithium alloy may optionally be used in combination with any lithium metal oxide/sulfide. In some such embodiments, the lithium ion battery further comprises an electrochemical system (e.g., comprising a suitable half-cell) according to any of the respective embodiments of the invention as a cathode.

Electrodes in a capacitor may optionally comprise the same substance capable of reversibly releasing lithium (or delithiated forms thereof) or different substances capable of reversibly releasing lithium (or delithiated forms thereof). In some embodiments, the anode and electrode of the capacitor comprise the same substance but differ in the amount of lithium therein, that is, in the degree of lithiation.

In some embodiments, the components of the lithium ion battery and/or supercapacitor are prepared (e.g., concurrently) according to a method described herein according to any of the respective embodiments (e.g., by fused filament fabrication).

Batteries and capacitors according to any of the respective embodiments described herein may optionally be of any size or shape, including non-standard free form sizes and shapes, optionally designed for direct integration into, and/or co-fabricated within, an electric device or component thereof, for example, electronic circuitry of a device.

As used herein the term “about” refers to ±20%. In some embodiments of any of the respective embodiments, the term “about” refers to ±10

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Materials and Methods

### Materials

C65 carbon was obtained from TIMCAL Ltd.

Carbon nanotubes (multi-walled, (—COOH)-functionalized) were obtained from US Research Nanomaterials, Inc.

Conductive graphene polylactic acid filament (BLACKMAGIC3D™) was obtained from Graphene 3D Lab.

1,3-Dioxolane was obtained from Sigma-Aldrich.

Graphite powder was obtained from SkySpring Nanomaterials, Inc.

LiFePO₄ (LFP) powder (Life Power® P2) was obtained from Clariant.

Li₄Ti₅O₁₂ (LTO) powder (Life Power® C-T2) was obtained from Clariant.

N-butyl-N-methylpyrrolidinium bistriflimide (PYR14TFS) was obtained from Solvionic.

Polyethylene oxide (5 MDa) and polyethylene glycol (2 kDa) were obtained from Sigma-Aldrich.

Polylactic acid (L175) was obtained from Corbion Purac.

Silicon nanoparticles were obtained from Tekna.

### Fused Filament Fabrication

The polyester polylactic acid (PLA) was selected as polymer. PLA is a thermoplastic polymer stable up to high temperatures, with a melting point of 170-180° C., and a degradation temperature of above 200° C. PLA pellets were dissolved in 1,3-dioxolane under stirring for 12 hours at room temperature.

Commercial LiFePO₄ (LFP) powder was used as active cathode material, and dispersed in combination with graphite powder, graphitized multi-walled, (—COOH)-functionalized carbon nanotubes and C65 carbon, at a ratio of 25:15:5:5% (w/w), respectively, using an ARE-250 mixer (Thinky, Japan) at 1500 rotations per minute for 15 minutes. The resulting homogeneous slurry was poured into a Teflon plate and dried for 12 hours at room temperature. After drying, it was crushed to the size of small composite pellets to be used for the fabrication of filament. LFP/PLA/carbon composites were extruded using a Nortek Pro filament extruder (Nortek, London) to form a filament suitable for use as feedstock in a fused filament fabrication 3D printer. With appropriate choice of the nozzle diameter (in the range of 1.4-1.7 mm) and careful control of the nozzle temperature (typically in the range 190-210° C.) and the extrusion speed, filaments with a circular cross section of average diameter of 1.75 mm (suitable for a commercially available 3D printer) and a typical standard deviation of 0.02-0.03 mm were produced.

The anode fabrication process was similar to that of the cathode, except that Li₄Ti₅O₁₂ (LTO) powder was used as an active electrode material.

Double spiral current-collector network was printed using a conductive graphene PLA filament (Graphene 3D Lab) and LTO-PLA anode. The printing was done with the Up-Plus 2 printer by UP3D. Printed disc and spiral-shape electrodes with a diameter of 15 mm and thickness of 200 μm were used as printed model cathode.

The printed samples were dried under vacuum at 100° C. for 12 hours to remove residual solvent.

### Electrode Performance Evaluation

For the initial cathode and anode tests, batteries prepared by fused filament fabrication were fabricated in coin cells (type 2032). The cells used in this work comprised a stainless steel current collector, a Celgard separator soaked in commercial electrolyte (1 M LiPF₆ in 1:1 EC:DEC, 2% VC) or 0.3 M LiTFSI-PYR₁₄TFSI ionic-liquid electrolyte, and a lithium anode foil. The cathode and anode prepared by fused filament fabrication were sonicated with the electrolyte for 5 minutes prior to the cell building. All subsequent handling of these materials took place under an argon atmosphere in a VAC glove box containing less than 10 ppm water and oxygen.

The printed electrochemical coin cells were constructed and electrochemically investigated using EIS, CV and galvanostatic cycling with a BCS-805 Biologic Instrument at 50° C. The charge-discharge tests were carried out in time-controlled mode at various current densities.

### Electron Microscopy

Surface ESEM (environmental scanning electron microscopy) micrographs of the printed electrode samples were taken with the Quanta 200 FEG ESEM. The samples were sputtered with a thin gold film (6 nm) prior to the scanning. TOF SIMS tests were performed with the use of a TRIFT II (Physical Electronics Inc., USA) under the following operating conditions: primary ions In⁺, DC sputtering rate 0.035 nm min⁻¹ based on SiO₂ reference.

### Example 1

### 3-Dimensional Printable Microbattery/Microcapacitor (3DPM) Designs

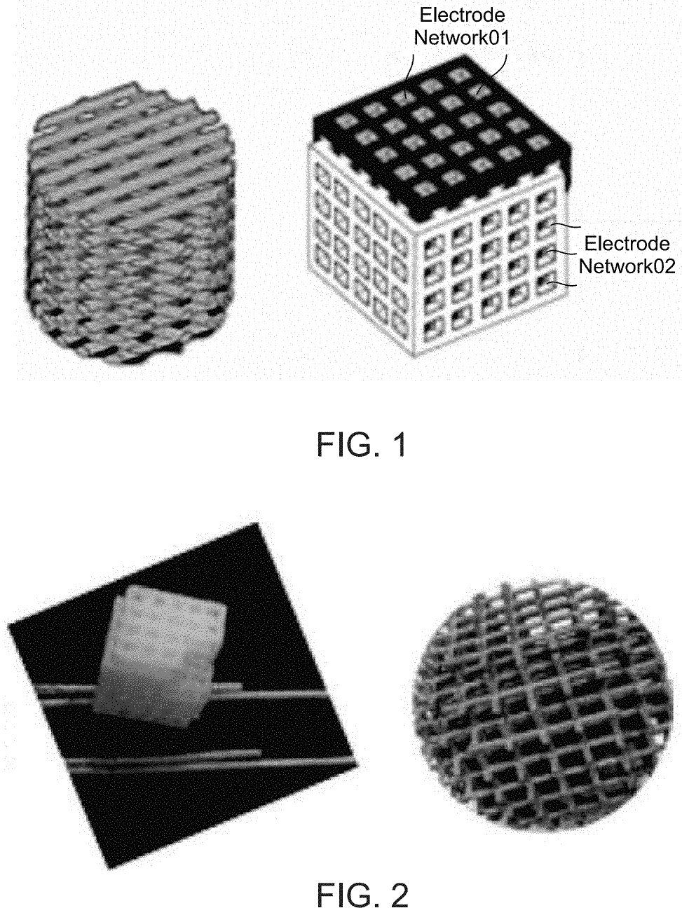

Free form-factor 3-dimensional printable microbattery/microcapacitor designs according to some embodiments of the invention involve forming thin interlaced fiber-like anode and cathode current collector networks (CCN), which are interlaced, but are not in a physical contact. The CCNs may be rectangular, cubical, prismatic, spherical, or may have any other desirable shape. FIG. 1 schematically depicts exemplary current collector networks (CCN). These, similarly to fiber scaffolds proposed for bone tissue engineering, can be of regular or irregular structures [Zhang et al., Synth Met 2016, 217:79-86]. FIG. 2 depicts 3D printed models (prepared by a stereolithography technique, using a commercial printing service)—more specifically, a cube (left panel) and network model (right panel).

The anode and cathode may optionally incorporate respective current collector networks, thus forming a core-shell structure with an electrode “shell” and current collector “core”. The cross-sectional shape of the anode and cathode core-shell structures can be, e.g., hexagonal, cubic, circular and/or spiral. The cross-sectional thickness of “shell” anode and/or “shell” cathode in the center of the electrode may vary from the thickness at the perimeter possessing gradient anisotropy.

FIG. 3 schematically depicts exemplary core-shell structures for electrodes/current collector networks (CCN). As shown therein, the cross-section or the filament may be a simple core-shell structure (upper row), or alternatively, the cross-section may comprise a relatively complex (e.g., spiral) pattern of current collector (lower row), which considerably enhances the contact area between the current collector and electrode.

FIG. 4 schematically depicts an internal view of an exemplary 3D printed battery or capacitor, with interlacing cathode/CCN and anode/CCN core-shell structures, separated by solid electrolyte which fills the space between the interlaced cathode and anode nets.

As can be seen in FIG. 4, the thinner a current collector is, the higher the interfacial area is between it and the electrode material, leading to higher power capability of the battery or capacitor.

### Example 2

### Effect of Battery Geometry on Battery Performance in a Model

To evaluate the area gain of simplified interlaced electrode networks architecture the following calculations have been carried out, using the theoretical model described below.

The electrode network according to the model is made of two rectangular interlaced 3D arrays of fiber-like electrodes. The fibers have a rectangular cross-section measuring D×D. The distance between the fibers is d. There are N fibers in a row, where N is the number of fibers that can be introduced along a line parallel to the side of the cube with length L:

N=floor(L/d)

Floor (X) designates that if the ratio L/D is not an integer one uses the lowest closest integer bounding X. The array has fibers in three orthogonal Cartesian directions along the sides of the cube. The surface area of the arrays is A_{S3}=12N²D(L−ND). It is noted that the area of an array that has fibers only in one direction is A_{S1}=4N²DL. Thus, the area gained using a 3D array has the ratio of:

A_{S3}/A_{S1}=3−3ND/L ≈3−3D/d

The thinner are the fibers and the smaller is the distance between them, the larger is the area gain of A_{S3} compared to A_{S1}. The area of a square 2D battery with a footprint of the cube is L². The area gained by the 3D array has the ratio of:

A_{S3}/A=12N²D(1/L−ND/L²)≈12DL/d²(1−D/d)

Since d>D and L>>d this ratio is positive and larger than 1. The volume of a 3D array is:

V_{S3}=L³+2N³R³−3N²LR²

The volume between the interlacing 3D fiber arrays is:

Vₑ=L³−2V_{S3}=6N²LD²−4N³D³−L³≈L³(6(D/d)²)−4(D/d)³−1)

Examining the formula of the approximated volume, it can be seen that the volume exists if and only if: (1+√3)/2≥D/d≥0.5

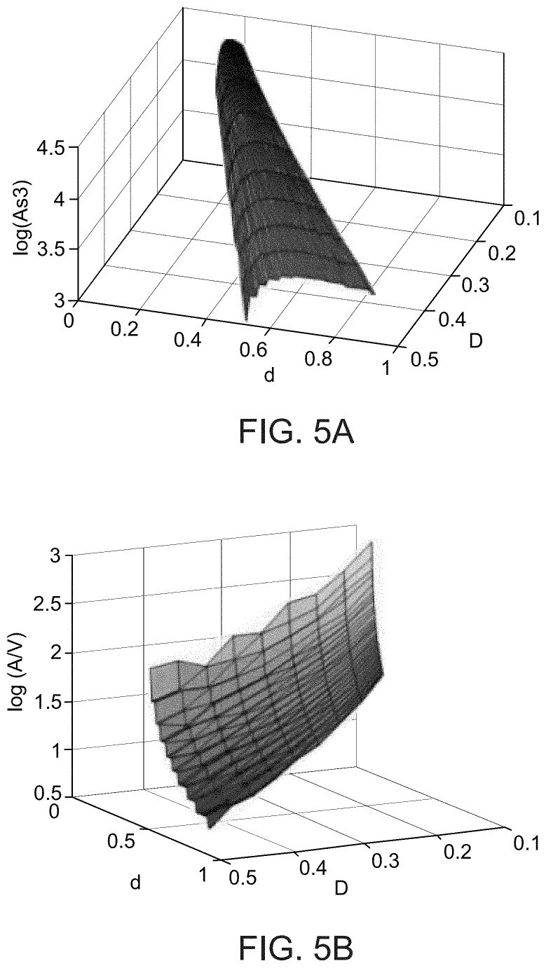

This limit bounds the distance D. The area and area to volume ratio (A_{S3}/V_{S3}) of a cubic electrode network with length of L=10 mm is depicted in FIGS. 5A and 5B.

As shown in FIGS. 5A and 5B, the range of D is between 0.1 and 0.5 mm and d is between 1.1D and 1.85 D (for L=10 mm). This is somewhat different from the approximated boundaries of [0.73D, 2D] derived from the approximated volume because of the floor function.

As further shown therein, V_{S3} increases steeply with d and increases slowly with D. The maximal volume is achieved at D=0.5, d=0.925 respectively and it is Ve=500 mm³. The surface area increases when D and d are small, and the maximal surface area is A_{S3}=17,776 mm². For example, for an array with L=10 mm; D=0.1 mm and d=0.183 mm, its surface area will be A_{S3}=16,096 mm² compared to a unidirectional array A_{S1}=12,178 mm² or a 2D array A_{S1}=100 mm². The volume of the active material is V_{S3}=440.12 mm³ between the arrays is Vₑ=119.74 mm³ which provides an area to volume ratio of A_{S3}/V_{S3}=134.42 mm⁻¹.

These calculations confirm that thinner electrode fibers and smaller distances between them are associated with a higher surface area to volume ratio for the interlaced network structure.

### Example 3

### Electrodes Printed by Fused Filament Fabrication (FFF)

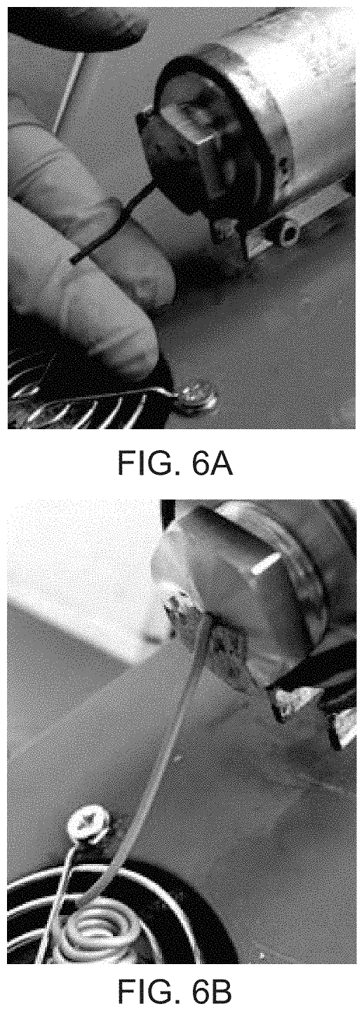

A variety of electrode architectures were printed by the FFF method, according to procedures described hereinabove, using multiple classes of materials. The filaments used for electrode fabrication were prepared by extrusion and contained 50-70% of active material, 10% of carbon additives, 20-40% of PLA. The composite LFP-PLA and LTO-PLA home-made filaments exhibited sufficient flexibility, ductility and toughness. Exemplary LFP-PLA and LTO-PLA extruded filaments are shown in FIGS. 6A and 6B, respectively.

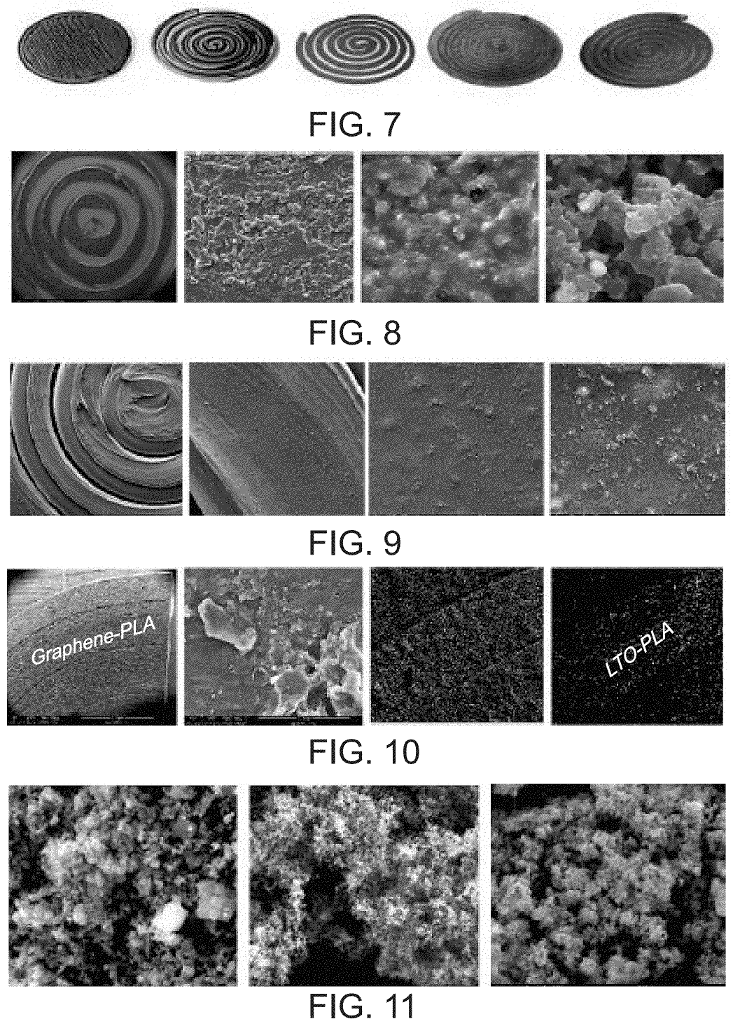

FIG. 7 shows disc and spiral-shaped printed electrodes comprising LFP-PLA or LTO-PLA. As further shown therein (on right), a double-spiral multi-material sample was prepared in which both spirals were printed simultaneously printed, comprising a current collector (graphene-PLA) inner ring and LTO-PLA outer ring.

FIGS. 8 and 9 show ESEM micrographs of FFF-printed LFP-PLA (FIG. 8) and LTO-PLA (FIG. 9) electrodes at different magnifications.

As shown in FIG. 8, strong agglomeration of LFP particles occurs, with the formation of a porous structure and significant roughness of the electrode surface. As further shown therein, the LFP particles were completely covered by the PLA polymer.

In contrast, as shown in FIG. 9, the surface morphology of the LTO-based anode is much smoother and denser than that of the LFP-based cathode. The individual LTO particles cannot be resolved in the ESEM micrographs, indicating better intermixing of the anode.

This result suggests that a higher surface charge and zeta potential of lithium titanate in a solvent such as dioxolane (used for the preparation of initial slurry for the extruder), as compared with lithium iron phosphate particles, results in a smooth and dense surface morphology.

As shown in FIG. 10, an FFF-printed double spiral structure of graphene-PLA current collector and LTO-PLA anode was prepared, as demonstrated by ESEM micrographs and EDS (energy dispersive x-ray spectroscopy) mapping.

Without being bound by any particular theory, it is believed that the use of nanosize LFP and LTO particles (e.g., as shown in FIG. 11) is advantageous as a result of the enhanced ionic diffusion of Lit It is further believed that supplementary carbon additive facilitates continuous electron percolation in the electrode.

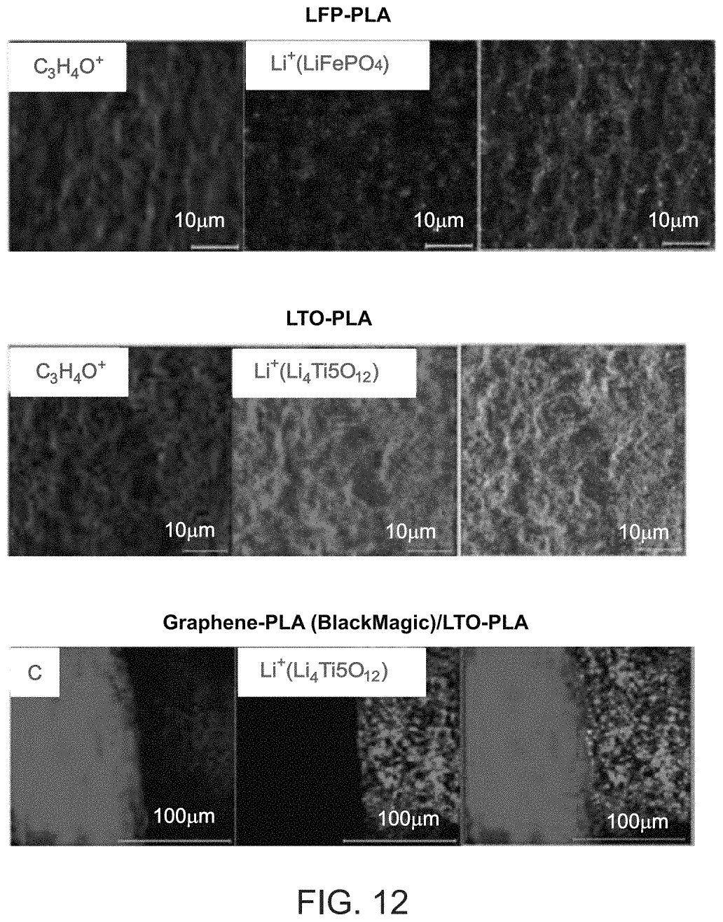

FIG. 12 presents TOFSIMS images of exemplary composite electrodes printed by FFF method, showing the lateral distribution of components acquired in the positive ions mode. The TOFSIMS data support the ESEM tests. The most intensive mass peak of polymer species in the spectra is that with a nominal mass 56, which corresponds to the C₃H₄O⁺ ion, which is formed by the bombardment of PLA. The intensity of lithium cation signal in the mass spectra was found to be higher than of iron, therefore Li⁺ was used to image a spatial distribution of the LFP and LTO. As can be seen from the comparison of TOFSIMS images, higher Li⁺ ionic yield and better homogeneity is observed for the LTO-based anode than of LFP-based cathode. The image of the double spiral LTO-current collector structure clearly shows the signal of lithium cation in the outer anode ring and its absence in the inner ring, which is associated with the current collector. In this case, the overlay (the right image) combines two images of carbon and lithium species obtained in positive and negative ions. The carbon ion image (in negative ions) is obtained after Cs sputtering, and the high C⁻ intensity comes mainly from the carbon content in PLA of anode, electron conducting additives and graphene component of graphene-PLA. The lithium ion image (in positive ions) is obtained after oxygen sputtering and it highlights the PLA-LTO area of the double spiral.

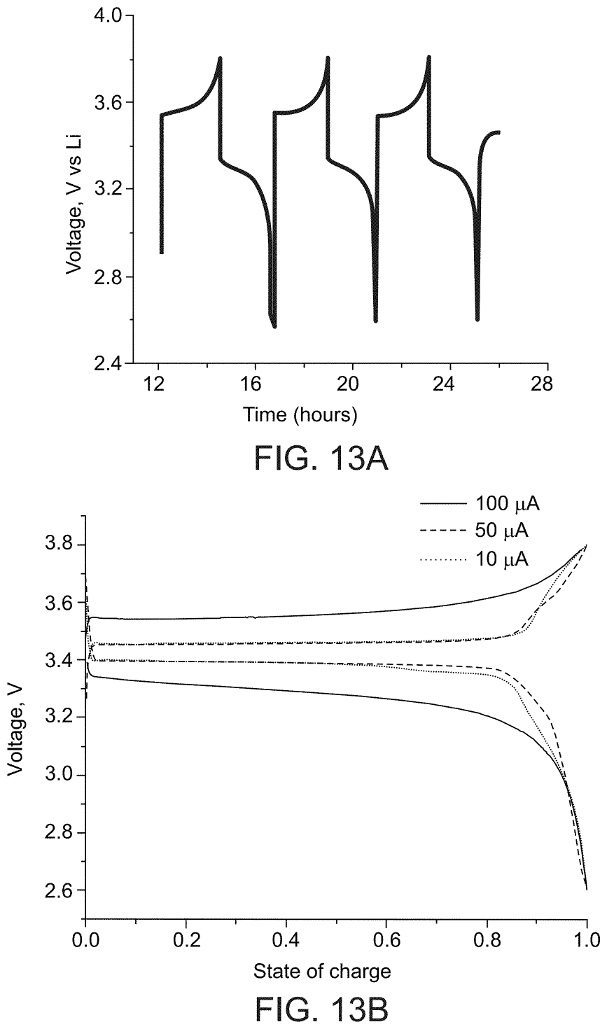

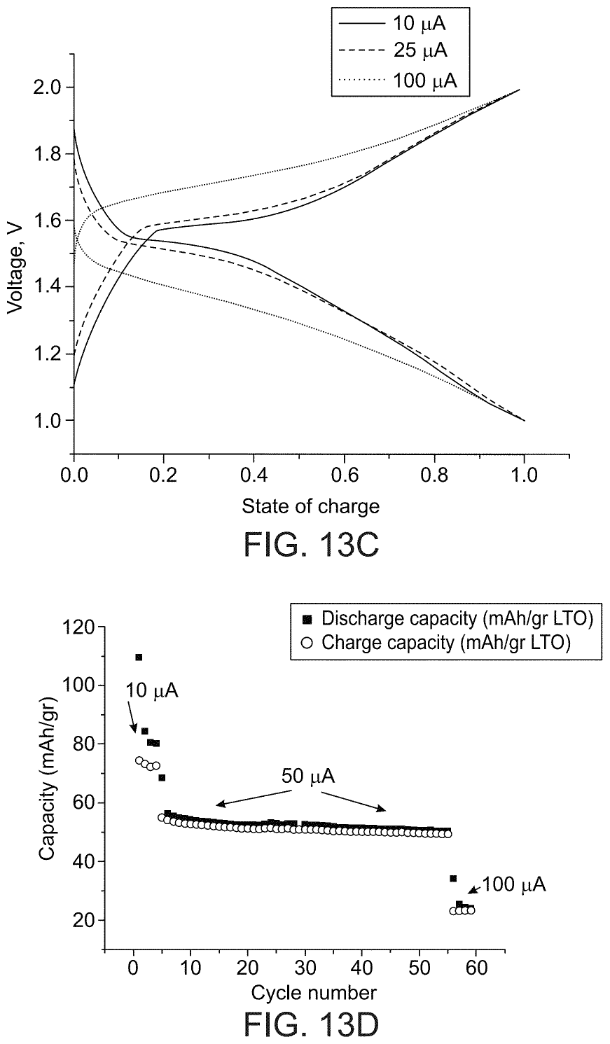

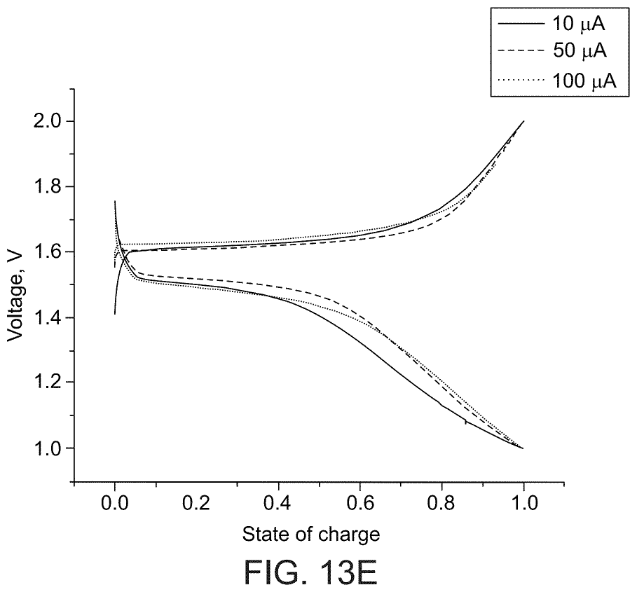

The results of electrochemical testing of Li/LFP and Li/LTO microbatteries assembled in coin-cell setup are shown in FIGS. 13A-13E. As shown therein, the voltage profile of the LFP-PLA cathode cycled between 3.8-2.6 V is presented as a function of capacity at 9 μAcm⁻², 44 μAcm⁻² and 88 μAcm⁻² charge and discharge current densities. The cycling of the cell resulted in 60, 50, 20 mA*hour/gr LFP at 9, 44 and 88 μAcm⁻², respectively. The data show utilization of about 50% of the theoretical capacity of LFP cathode at very low cycling rate. The utilization of the electrode active material depends on the complex interplay between the electronic conduction created by carbon additives, and ionic conductivity of the composite polymer electrode. Since PLA is not a lithium ion-conducting polymer, its ionic conductivity is gained by a formation of gel following the swelling of the polymer with liquid organic electrolyte. The limited utilization of the active material originates from the non-optimal distribution of active electrode materials and conducting additives and long diffusion path of lithium ions in the polymer phase, caused by the combined effect of thick electrodes and insufficient amount of impregnated electrolyte. Increase in current density on cycling of Li/LFP cell by an order of magnitude is followed by a 3.5 times increase of charge-discharge overpotential, while for Li/LTO cell the overpotential growth is half that. This may be caused by poor homogeneity and higher specific resistance of the printed LFP cathode. At low C-rates the specific capacity of Li/LTO cell is 80 mA*hour/gram, which is also only 50% of the theoretical value for LTO. The Li/LTO cell ran for 60 reversible cycles at 30 μA/cm² (FIG. 13D) and the test continued. The capacity increased by 10% (to 60%) when the double spiral LTO current collector was used.

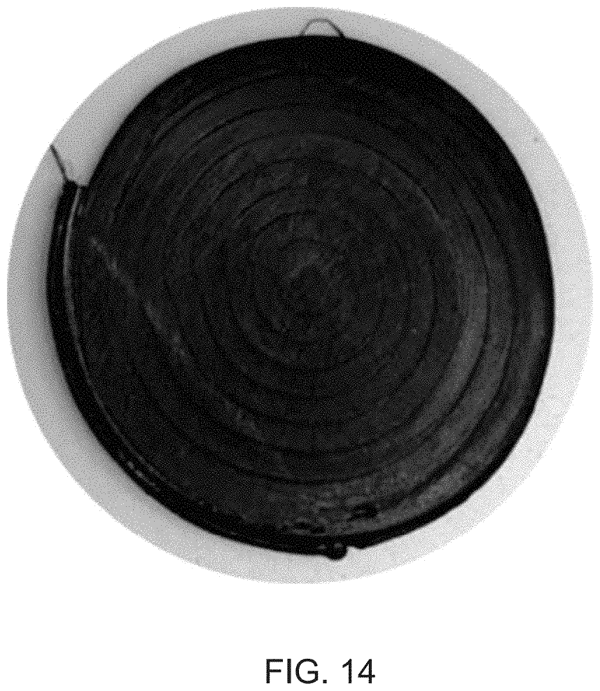

The ability of a plasticizer to enhance performance of LFP electrodes was assessed. Low-molecular-weight polyethylene glycol (PEG), having an average molecular weight of about 2000 Da, was used as the plasticizer, at a concentration of 1 weight percent. A coin cell-type LFP-PLA cathode was then prepared by fused filament fabrication, as depicted in FIG. 14, and tested by galvanotactic cycling as described hereinabove.

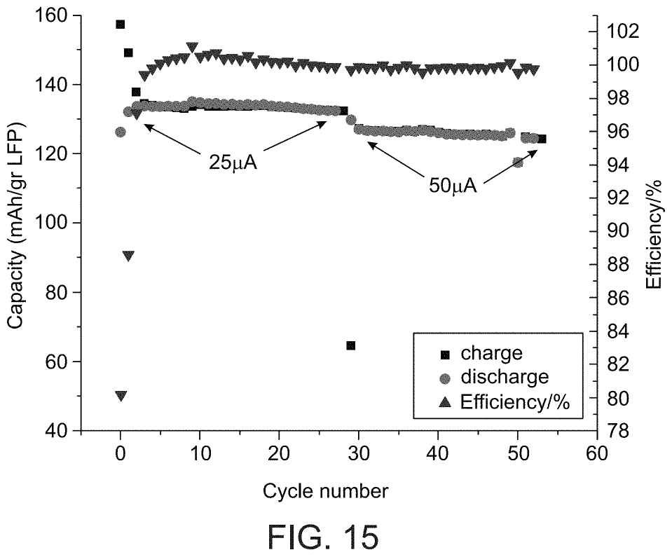

As shown in FIG. 15, addition of a small amount (1 weight percent) of PEG to an LFP-PLA cathode resulted in a capacity of 130 mA*hour per gram LFP, which is close to the theoretical capacity, along with close to 100% coulombic efficiency.

This result indicates that plasticizers can enhance the performance of FFF-printed polymer-based lithium ion cathodes.

Without being bound by any particular theory, it is believed that the plasticizer enhances electrode performance by enhancing liquid-electrolyte impregnation into the composite-polymer electrodes.

It is important to emphasize that the profiles of voltage vs. charge/discharge time and vs. state-of-charge of the cells containing printed LFP or LTO electrodes are similar to the typical profiles of the cells with commercial electrodes.

A preliminary model was prepared as proof of concept for an FFF-printed electrode with different patterns than in electrodes discussed hereinabove. The model was prepared according to procedures such as described hereinabove, except that PLA was used per se instead of a PLA-lithium metal oxide composite material such as described hereinabove.

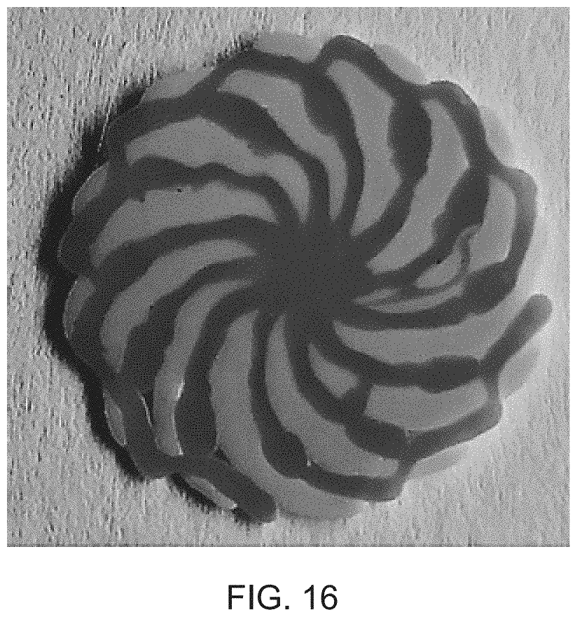

FIG. 16 shows a preliminary model for an FFF-printed electrode (1 cm diameter, 0.3 mm thickness), with an interlocking pattern of PLA (light) and graphene-PLA current collector (dark). This model indicates that a functional FFF-printed electrode with a corresponding pattern can be prepared using a PLA-lithium metal oxide composite material such as described hereinabove instead of PLA in the light portions. In addition, it is believed that higher pattern accuracy could be achieved with a more accurate commercially available FFF 3D printer.

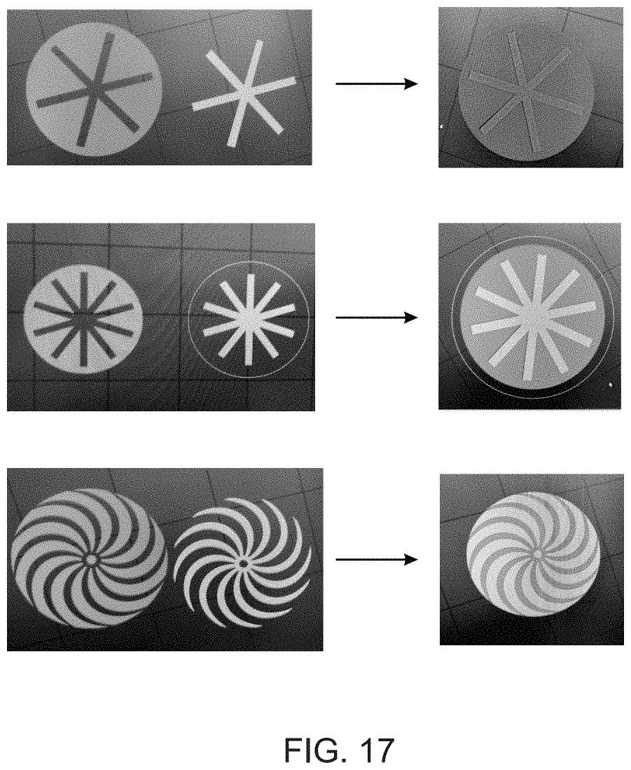

Additional exemplary electrode patterns are depicted in FIG. 17.

The above results provide good proof of a concept of the successful printing of free form-factor battery electrodes by fused filament fabrication.

### Example 4

### Quasi-Solid Polymer Electrolyte Prepared by Fused Filament Fabrication (FFF)

Three polymer-based membranes were prepared by fused filament fabrication (according to procedures such as described herein), using various mixtures of PLA, PEO (average molecular weight of about 5,000,000 Da) and PEG (average molecular weight of about 2,000 Da). The membranes were wetted by 20 microliters of 0.3 M LiTFSI-PYR14TFS (lithium bistriflimide-N-butyl-N-methylpyrrolidinium bis(trifluoromethylsulfonyl)imide) electrolyte. The electrolyte was completely absorbed by the membrane, forming a plasticized solid system.

The conductivity at 60° C. of a polymer electrolyte formed from 25% PLA, 40% PEO and 35% PEG was 0.1 mS/cm, and the conductivity at 60° C. of a polymer electrolyte formed from 50% PEO and 50% PEG was 0.2 mS/cm, as determined by measuring AC impedance.

These results indicate the feasibility of FFF-printing both an electrolyte and an electrode, for example, to form a 3D-printed battery or capacitor.

### Example 5

### Solid Polymer Electrolyte for Fused Filament Fabrication

Four solid electrolytes were prepared from PLA, PEO (average molecular weight of about 5,000,000 Da) and PEG (average molecular weight of about 2,000 Da) at different PLA:PEO:PEG ratios. The solid electrolytes further contained 25-30% LiTFSI salt, added in solid form to the polymer. The melting points of the solid electrolytes were about 200° C., which is suitable for fused filament fabrication (e.g., 3D-printing).

### Example 6

### Composite Solid Polymer Electrolyte for Fused Filament Fabrication

Solid electrolytes were prepared from a mixture of PLA, PEO (average molecular weight of about 5,000,000 Da) and PEG (average molecular weight of about 2,000 Da), 1-50% solid ion-conducting ceramics (LAGP (Li_{1.5}Al_{0.5}Ge_{1.5}P₃O₁₂) or LLZO (Li₇La₃Zr₂O₁₂) garnet), and LiTFSI salt. The melting points of the solid electrolytes were about 250° C., which is suitable for fused filament fabrication (e.g., 3D-printing).

### Example 7

### Silicon Electrodes Prepared by Fused Filament Fabrication

Composite anodes, containing silicon nanoparticles as active anode material, were prepared by dispersing silicon nanoparticles in PLA and PEO, in combination with graphite powder, graphitized multi-walled, (—COOH)-functionalized carbon nanotubes (MWCNT) and/or carbon black (C65 carbon), for example, in the following proportions: Si—about 10-20%, MWCNT—about 10%, carbon black (C65 carbon)—about 10%, PEO—about 10%, PLA—about 60%.

### Example 8

### Composite Cathode With Lithium Polyacrylate

Lithium polyacrylate (LiPAA) is added to a composite cathode containing LFP and PLA, with the aim of enhancing conductivity, integrity and mechanical stability of the electrode for lithium ion batteries or capacitors. LiPAA was prepared by reacting a polyacrylic acid (PAA) polymer with LiOH.

### Example 9

### Additional Structures Prepared by Fused Filament Fabrication (FFF)

Additional FFF-printed structures are prepared according to procedures described herein, with different types of polymer and/or conductive additive; different polymer-to-active material and/or polymer-to-conducting additive ratio; and/or with the use of different plasticizers, such as propylene carbonate. The effect of such modifications on enhancing the percolation of the active material with the conducting additives—so as to enhance liquid-electrolyte impregnation into the composite-polymer electrodes—is assessed, in order to develop an additional printable solid electrolyte, thereby facilitating construction of a solid-state free form-factor battery or capacitor.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method of manufacturing an electrochemical system which comprises at least one lithium-based electrode, the method comprising dispensing, in a configured pattern corresponding to the shape of the electrode, at least a first model composition which comprises at least one substance capable of reversibly releasing lithium or a delithiated form of said substance, wherein said dispensing comprises heating a filament comprising said first model composition and dispensing a heated composition.

2. The method of claim 1, wherein said substance is a lithium metal oxide/sulfide.

3. The method of claim 1, wherein said substance is a lithium alloy.

4. The method of claim 1, wherein said first model composition further comprises a thermoplastic polymer.

5. The method of claim 1, wherein said electrode is a three-dimensional electrode, the method comprising sequentially forming a plurality of layers in said configured pattern, wherein for at least a few of said layers said forming comprises said dispensing of said first model composition.

6. The method of claim 1, wherein said electrochemical system further comprises a current collector which comprises a conductive material, said current collector being in physical contact with at least a portion of said electrode, the method further comprising dispensing a second model composition which comprises said conductive material, wherein dispensing said first and said second model compositions is in a configured pattern corresponding to the shape of the electrochemical system.

7. The method of claim 6, wherein dispensing said second model composition comprises heating a filament comprising said second model composition to obtain a heated second model composition and dispensing said heated second model composition.

8. The method of claim 6, comprising forming a filament that comprises said first model composition and said second model composition, heating said filament to obtain a heated first model composition and heated second model composition, and dispensing said heated first model composition and said heated second model composition.

9. The method of claim 6, wherein said second model composition further comprises a thermoplastic polymer.

10. The method of claim 1, comprising manufacturing at least two electrodes, each of said electrodes being independently formed in a respective configured pattern.

11. The method of claim 1, wherein said electrochemical system further comprises an electrolyte, the method further comprising dispensing a third model composition which comprises said electrolyte, in a configured pattern corresponding to the shape of the electrolyte in said electrochemical system.

12. The method of claim 11, wherein said third model composition comprises a thermoplastic polymer and at least one compound comprising lithium ions.

13. An electrochemical system which comprises at least one lithium-based electrode, manufactured according to the method of claim 1.

14. An electrochemical system which comprises:
(a) at least one lithium-based electrode, said electrode comprising a first composite material, the first composite material comprising a thermoplastic polymer and at least one substance capable of reversibly releasing lithium or a delithiated form of said substance, wherein at least 20 weight percents of said first composite material is said thermoplastic polymer;
(b) a current collector in physical contact with at least a portion of said electrode, said current collector comprising a second composite material which comprises a thermoplastic polymer and a conductive material; and
(c) an electrolyte.

15. An electrochemical system which comprises at least one lithium-based electrode, said electrode comprising a first composite material, the first composite material comprising a thermoplastic polymer and at least one substance capable of reversibly releasing lithium or a delithiated form of said substance, wherein at least 20 weight percents of said first composite material is said thermoplastic polymer.

16. The electrochemical system of claim 15, wherein said substance is a lithium metal oxide/sulfide.

17. The electrochemical system of claim 15, wherein said substance is a lithium alloy.

18. The electrochemical system of claim 15, wherein said first composite material further comprises a plasticizer.

19. The electrochemical system of claim 15, wherein said electrode is a three-dimensional electrode.

20. The electrochemical system of claim 15, further comprising a current collector in physical contact with at least a portion of said electrode, wherein said current collector comprises a second composite material which comprises a thermoplastic polymer and a conductive material.

21. The electrochemical system of claim 15, comprising at least two electrodes, each of said electrodes comprising a thermoplastic polymer and at least one substance capable of reversibly releasing lithium or a delithiated form of said substance.

22. The electrochemical system of claim 21, wherein at least two of said electrodes are interlaced with respect to one another.

23. The electrochemical system of claim 15, comprising an electrochemical half-cell which comprises said electrode and an electrolyte.

24. A lithium ion battery or supercapacitor comprising at least one electrochemical system according to claim 23.

25. A lithium ion battery comprising the electrochemical system of claim 23, wherein:
said electrode is a cathode and said substance capable of reversibly releasing lithium is a lithium metal oxide/sulfide, the battery further comprising a lithium ion anode; and/or
said electrode is an anode and said substance capable of reversibly releasing lithium is selected from the group consisting of lithium titanate (LTO) and a lithium alloy, the battery further comprising a lithium ion cathode.

26. A lithium ion battery comprising the electrochemical system of claim 21, and an electrolyte.

27. A lithium ion battery or supercapacitor manufactured according to the method of claim 11.

28. A method of manufacturing an electrochemical system which comprises at least one electrode, the method comprising dispensing, in a configured pattern corresponding to the shape of the electrode, at least a first model composition which comprises at least one substance capable of reversibly releasing an electrochemically-active agent or a depleted form of said substance, wherein said dispensing comprises heating a filament comprising said first model composition and dispensing a heated composition.

29. An electrochemical system which comprises at least one electrode, said electrode comprising a first composite material, the first composite material comprising a thermoplastic polymer and at least one substance capable of reversibly releasing an electrochemically-active agent or a depleted form of said substance, wherein at least 20 weight percents of said first composite material is said thermoplastic polymer.

30. A battery or capacitor comprising at least one electrochemical system according to claim 29.
